(19) United States
(12) Patent Application Publication
(10) Pub. No.: US 2026/0292718 A1
(43) Pub. Date: Sep. 24, 2026

(54) AGC SYMBOL PATTERNS IN TIME-INTERLACED SENSING TRANSMISSIONS

(71) Applicant: QUALCOMM Incorporated, San Diego, CA (US)

(72) Inventors: Stelios STEFANATOS, San Diego, CA (US); Preeti KUMARI, San Diego, CA (US); Kapil GULATI, Belle Mead, NJ (US); Shijun WU, San Diego, CA (US); Junyi LI, Greentown, PA (US)

(21) Appl. No.: 19/474,501

(22) PCT Filed: Apr. 15, 2024
(86) PCT No.: PCT/US2024/024638

§ 371 Date: Oct. 10, 2025

(30) Foreign Application Priority Data
May 8, 2023 (GR) 20230100370

(51) Int. Cl. H04W 52/52; H04W 4/38; H04W 72/231; H04W 92/18

(52) U.S. Cl. CPC H04W 52/52; H04W 4/38; H04W 72/231; H04W 92/18

(57) ABSTRACT

Method and apparatus for a configuration for AGC patterns for time-interlaced sensing transmissions. The apparatus transmits a sensing interlace transmission comprising an interlace pattern of sensing symbols over a plurality of slots. The apparatus transmits an AGC signal in a first symbol of each slot of the plurality of slots comprising at least one sensing symbol of the sensing interlace transmission or prior to each contiguous set of one or more sensing symbols of the sensing interlace transmission. The apparatus may receive an indication to transmit the AGC signal in the first symbol of each slot of the plurality of slots comprising the at least one sensing symbol or prior to each contiguous set of the one or more sensing symbols of the sensing interlace transmission.

### CROSS-REFERENCE TO RELATED APPLICATION

This application claims the benefit of Greek Patent Application Serial No. 20230100370, entitled “AGC SYMBOL PATTERNS IN TIME-INTERLACED SENSING TRANSMISSIONS” and filed on May 8, 2023, which is expressly incorporated by reference herein in its entirety.

### TECHNICAL FIELD

The present disclosure relates generally to communication systems, and more particularly, to a configuration for automatic gain control (AGC) patterns for sensing transmissions.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication at a user equipment (UE). The apparatus may be a device at a UE. The device may be a processor and/or a modem at a UE or the UE itself. The apparatus transmits a sensing interlace transmission comprising an interlace pattern of sensing symbols over a plurality of slots. The apparatus transmits an automatic gain control (AGC) signal in a first symbol of each slot of the plurality of slots comprising at least one sensing symbol of the sensing interlace transmission or prior to each contiguous set of one or more sensing symbols of the sensing interlace transmission.

In an aspect of the disclosure, a method, a computer-readable medium, and an apparatus are provided for wireless communication at a UE. The apparatus may be a device at a UE. The device may be a processor and/or a modem at a UE or the UE itself. The apparatus receives an allocation of resources for an uplink transmission or a sidelink transmission with a starting symbol after a first symbol in a slot. The apparatus transmits in a first symbol of the slot corresponding to the uplink transmission or the sidelink transmission.

In an aspect of the disclosure, a method, a computer-readable medium, and an apparatus are provided for wireless communication at a network node. The apparatus may be a device at a network node. The device may be a processor and/or a modem at a network node or the network node itself. The apparatus provides an indication for a UE to transmit an AGC signal in a first symbol of each slot of a plurality of slots comprising at least one of an sensing symbol of a sensing interlace transmission, an uplink transmission having a starting symbol allocated after the first symbol of a slot, or a sidelink transmission having a starting symbol allocated after the first symbol of a slot; or prior to each contiguous set of one or more sensing symbols of the sensing interlace transmission. The apparatus provides, to the UE, an allocation of resources for at least one of the sensing interlace transmission comprising sensing symbols over one or more slots, the uplink transmission starting after the first symbol of the slot, or the sidelink transmission starting after the first symbol of the slot.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network, in accordance with various aspects of the present disclosure.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network, in accordance with various aspects of the present disclosure.

FIG. 4A illustrates example aspects of a sensing signal transmission and reception, in accordance with various aspects of the present disclosure.

FIG. 4B is a diagram illustrating an example of UEs performing sensing transmissions over the same time and frequency resources, in accordance with various aspects of the present disclosure.

FIG. 5 is a diagram illustrating an example of misaligned sensing transmissions, in accordance with various aspects of the present disclosure.

FIG. 6 is a diagram illustrating an example of UEs performing sensing transmissions over the same time and frequency resources, in accordance with various aspects of the present disclosure.

FIG. 7 is a diagram illustrating an example of multiplexed sensing transmissions and communication transmissions, in accordance with various aspects of the present disclosure.

FIG. 8 is a diagram illustrating an example of an AGC transmission pattern, in accordance with various aspects of the present disclosure.

FIG. 9 is a diagram illustrating an example of an AGC transmission pattern, in accordance with various aspects of the present disclosure.

FIG. 10 is a call flow diagram of signaling between a UE and a base station, in accordance with various aspects of the present disclosure.

FIG. 11 is a call flow diagram of signaling between a UE and a base station, in accordance with various aspects of the present disclosure.

FIG. 12 is a flowchart of a method of wireless communication at a UE, in accordance with various aspects of the present disclosure.

FIG. 13 is a flowchart of a method of wireless communication at a UE, in accordance with various aspects of the present disclosure.

FIG. 14 is a diagram illustrating an example of a hardware implementation for an example apparatus and/or UE.

FIG. 15 is a flowchart of a method of wireless communication at a UE, in accordance with various aspects of the present disclosure.

FIG. 16 is a flowchart of a method of wireless communication at a UE, in accordance with various aspects of the present disclosure.

FIG. 17 is a diagram illustrating an example of a hardware implementation for an example apparatus and/or UE.

FIG. 18 is a flowchart of a method of wireless communication at a network node, in accordance with various aspects of the present disclosure.

FIG. 19 is a flowchart of a method of wireless communication at a network node, in accordance with various aspects of the present disclosure.

FIG. 20 is a diagram illustrating an example of a hardware implementation for an example network entity or network node, in accordance with various aspects of the present disclosure.

### DETAILED DESCRIPTION

Wireless communication systems may also support wireless sensing transmissions by various devices. Sensing transmissions may be treated as a new type of traffic supported by the network. The sensing transmissions or sensing applications may be transparent to users from a PHY or MAC perspective, and the sensing transmissions may use the same waveforms and PHY procedures as other wireless communication in the network. Sensing transmissions may have higher demands in terms of bandwidth, a sensing duration, and/or a sensing duty cycle. A large number of slots and resource blocks or subchannels may be occupied by a single device performing sensing transmissions, each time the single device transmits a sensing signal in each sensing cycle. This overhead for sensing transmissions may be further increased when analog beam sweeping is performed by the sensing UE to scan a larger angular surveillance region. As such, this overhead may impact resource availability when multiple UEs share the spectrum while performing communications and/or sensing transmissions.

Greater spectrum efficiency can be enabled when multiple UEs perform the sensing transmission over the same time and frequency resources using RE-based and symbol-based interlacing. RE-based and symbol-based interlacing may include resource patterns for sensing transmissions towards efficient multiplexing of multiple UEs over the same bandwidth and same sensing duration. In some instances, time and frequency resources of each sensing transmission may be spaced over time and frequency in a pattern or non-regular pattern. A sensing transmitting UE may include the reception of the sensing transmission, and with multiple UEs being frequency domain multiplexed, each receiving UE may perform an AGC adjustment before processing the received or sensing signal.

In some instances, multiple UEs may be configured with frequency domain multiplexed sensing transmissions that are not aligned and/or are frequency domain multiplexing with non-sensing transmissions (e.g., uplink or sidelink communication). For example, a first UE may initiate a sensing transmission and a second UE may initiate a different type of transmission (e.g., uplink transmission granted by the network) in a later slot, while the first UE is still transmitting. The receive power level of sensing UEs may not be constant within the sensing duration and the power readings based on the AGC symbols at the sensing duration start may not apply throughout.

Sensing transmissions performed within a bandwidth used for communication purposes may improve system efficiency and add value to communication assets. However, as sensing transmission span multiple slots, the resource overhead may be large. Aspects presented herein provide improved time and frequency interlace patterns allow for more efficient resource use by multiplexing of UEs, while also providing resources that enables more accurate AGC measurements for sensing transmission. For example, the patterns provided herein enable AGC measurements for other transmissions (e.g., sensing, uplink, sidelink transmissions) that happen to be frequency domain multiplexed with the sensing transmission during various portions of the transmission sensing duration.

Aspects presented herein provide a configuration for AGC patterns for minimizing AGC issues in time-interlaced sensing transmissions. For example, the disclosure may propose an enhanced sensing AGC symbol format to accommodate instances where frequency domain multiplexed sensing transmissions are not aligned and/or are frequency domain multiplexing with transmissions (e.g., uplink or sidelink).

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. In instances where multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

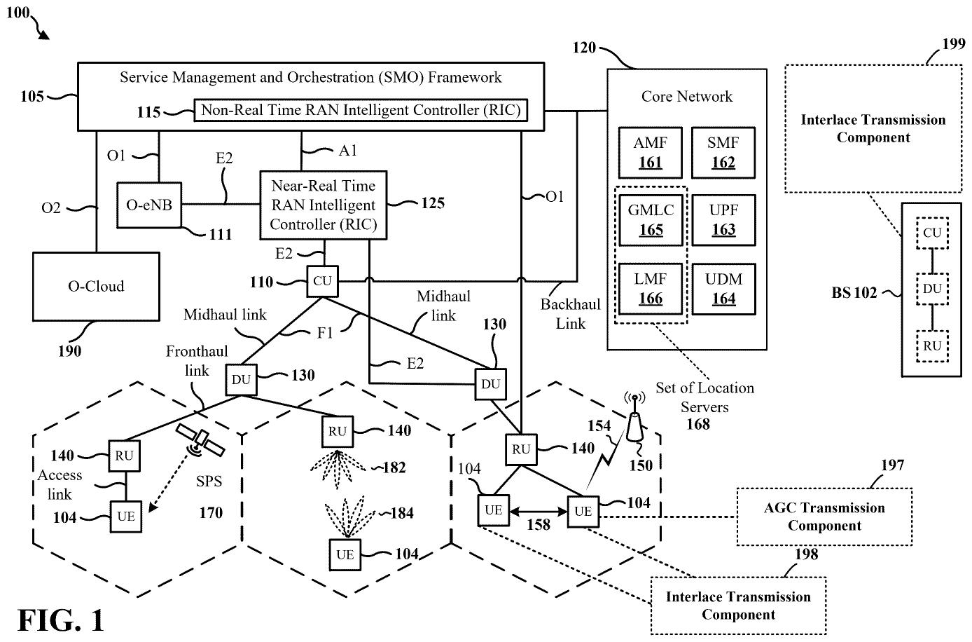

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Some UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

Some examples of sidelink communication may include vehicle-based communication devices that can communicate from vehicle-to-vehicle (V2V), vehicle-to-infrastructure (V2I) (e.g., from the vehicle-based communication device to road infrastructure nodes such as a Road Side Unit (RSU)), vehicle-to-network (V2N) (e.g., from the vehicle-based communication device to one or more network nodes, such as a base station), vehicle-to-pedestrian (V2P), cellular vehicle-to-everything (C-V2X), and/or a combination thereof and/or with other devices, which can be collectively referred to as vehicle-to-anything (V2X) communications. Sidelink communication may be based on V2X or other D2D communication, such as Proximity Services (ProSe), etc. In addition to UEs, sidelink communication may also be transmitted and received by other transmitting and receiving devices, such as Road Side Unit (RSU) 107, etc. Sidelink communication may be exchanged using a PC5 interface, in some aspects.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in some aspects, the UE 104 may comprise an interlace transmission component 198 configured to transmit a sensing interlace transmission comprising an interlace pattern of sensing symbols over a plurality of slots; and transmit an AGC signal in a first symbol of each slot of the plurality of slots comprising at least one sensing symbol of the sensing interlace transmission or prior to each contiguous set of one or more sensing symbols of the sensing interlace transmission.

In some aspects, a UE may include an AGC transmission component 197 configured to receive an allocation of resources for an uplink transmission or a sidelink transmission with a starting symbol after a first symbol in a slot; and transmit in a first symbol of the slot corresponding to the uplink transmission or the sidelink transmission.

Referring again to FIG. 1, in some aspects, the base station 102 may comprise an interlace transmission component 199 configured to provide an indication for a UE to transmit an AGC signal in a first symbol of each slot of a plurality of slots comprising at least one of an active symbol of a sensing interlace transmission, an uplink transmission having a starting symbol allocated after the first symbol of a slot, or a sidelink transmission having a starting symbol allocated after the first symbol of a slot; or prior to each contiguous set of one or more sensing symbols of the sensing interlace transmission; and provide, to the UE, an allocation of resources for at least one of the sensing interlace transmission comprising sensing symbols over one or more slots, the uplink transmission starting after the first symbol of the slot, or the sidelink transmission starting after the first symbol of the slot.

Although the following description may be focused on 5G NR, the concepts described herein may be applicable to other similar areas, such as LTE, LTE-A, CDMA, GSM, and other wireless technologies.

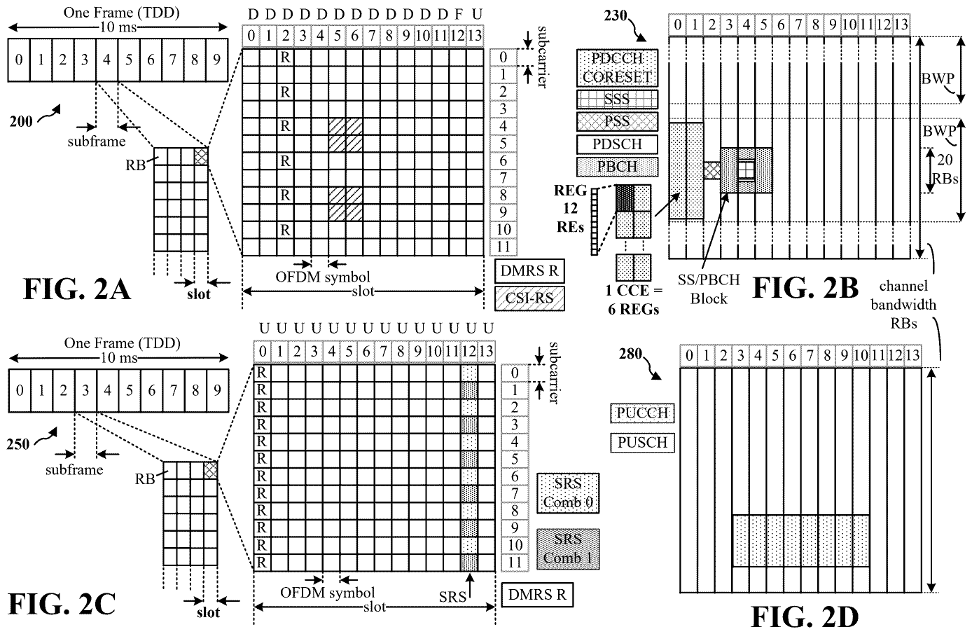

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

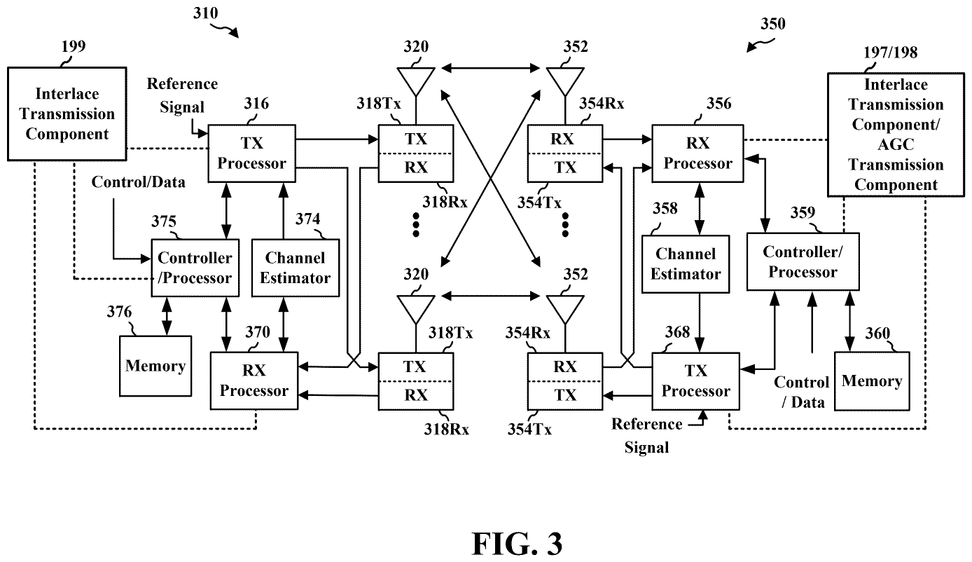

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the interlace transmission component 198 and/or an AGC transmission component 197 of FIG. 1.

At least one of the TX processor 316, the RX processor 370, and the controller/processor 375 may be configured to perform aspects in connection with the interlace transmission component 199 of FIG. 1.

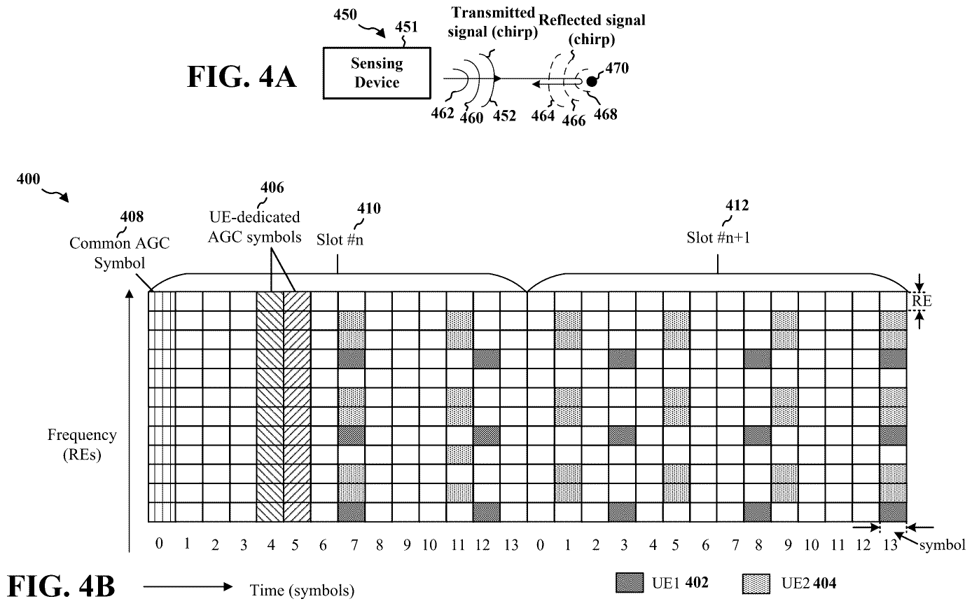

As an example of wireless signal transmission and reception, a device may support sensing procedures. FIG. 4A is a diagrams 450 illustrating an example of sensing signals that are generated from a sensing device 451 (e.g., a device transmitting and measuring a radar signal) that may be used to measure at least one value associated with a corresponding at least one object in an environment of the radar device in accordance with various aspects of the present disclosure. The sensing device 451 may detect an object 470 by transmitting a set of sensing transmissions, which may be a set of radar signals and may be referred to as a set of chirp signals or pulse signals, where each of the sensing signals may have a frequency that varies linearly (e.g., have a frequency sweeping) over a fixed period of time (e.g., over a sweep time) by a modulating signal. In some aspects, a chirp waveform may comprise a CP-OFDM symbol.

After one or more OFDM symbols (e.g., sensing symbols 452, 460, 462, etc.) are transmitted by the sensing device 451, the transmitted sensing symbols may reach the object 470 and reflect back to the sensing device 451, such as shown by the reflected symbols (e.g., reflected sensing symbols 464, 466, and 468, which may correspond to the transmitted sensing symbols 452, 460, and 462, respectively). As there may be a distance between the sensing device 451 and the object 470 and/or it may take time for a transmitted sensing symbol to reach the object 470 and reflect back to the sensing device 451, a delay may exist between a transmitted sensing symbols and its corresponding reflected chirp. The delay may be proportional to a range between the sensing device 451 and the object 470 (e.g., the further the target, the larger the delay and vice versa). Thus, the sensing device 451 may be able to measure or estimate a distance between the sensing device 451 and the object 470 based on the delay.

Sensing procedures may be a part of wireless communication systems, or may be supported by devices that communicate via the wireless communication system. In one example, a wireless communication device may be capable of performing on-demand RF sensing procedures, e.g., in order to provide sensing as a service. In another example, sensing-assisted communications may include sensing performed transparently to the user in an effort to improve the wireless communication performance, such as but not limited to using sensing to identify or predict optimal communication beams for transmitting and receiving wireless communication. In both examples, sensing transmissions may be performed over the same time-frequency resources as other wireless communication transmissions, in order to improve system spectral efficiency and reuse mechanisms for coordinated channel access (e.g., collision avoidance). Sensing transmissions may be treated as a new type of wireless traffic supported by a wireless network. In some aspects, the sensing transmissions or applications may be transparent from a PHY or MAC perspective, using the same waveforms and PHY procedures as any other communication transmission or application. For example, an OFDM may be used as a sensing waveform. As an example, an NR waveform may be used for a sensing waveform, e.g., as described in connection with FIG. 4A.

Sensing transmissions may have high demands in terms of bandwidth, sensing duration (e.g., coherent processing interval (CPI)), or sensing duty cycle. For example, in automotive applications, a sensing bandwidth may comprise 100 MHz or more and CPI of 10-20 ms. Sensing cycles may be reduced to values of 100 ms or less, in some aspects. For example, a device may transmit sensing signals more frequently, e.g., with a shorter cycle, in order to have a more accurate measurement of the device's surroundings. A large number of slots and resource blocks or subchannels may be occupied by a single device, each time the single device transmits a sensing signal in each sensing cycle. This overhead may be further increased when analog beam sweeping is performed by the sensing UE to scan a large angular surveillance region. As such, this overhead may impact resource availability when multiple UEs share the spectrum while performing communications and/or sensing transmissions.

FIG. 4B is a time and frequency resource diagram 400 illustrating an example of two UEs (e.g., UE1 402, UE2 404) performing sensing transmissions over the same time and frequency resources. The two UEs (e.g., UE1 402, UE2 404) may perform the sensing transmission over the same time and frequency resources using RE-based and symbol-based interlacing. RE-based interlacing includes the transmission from one UE being transmitted in REs that are interlaced between REs used by the other UE. Symbol-based interlacing includes the transmissions from one UE on symbols between the symbols transmitted by the other UE. RE-based and symbol-based interlacing may include resource patterns for sensing transmissions towards efficient multiplexing of multiple UEs over the same bandwidth and same CPI. An FDM pattern for the interlace may be signaled by a network, in some aspects. In other aspects, a UE may signal the resources, e.g., as a resource reservation. In some instances, time and frequency resources of each sensing transmission may be spaced over time (e.g., symbols) and frequency (e.g., REs). In some instances, time and frequency resources of each sensing transmission may be spaced over time and frequency in a non-regular pattern. A UE transmitting a sensing transmission may also receive the sensing transmission, and with multiple UEs being frequency domain multiplexed, each receiving UE may perform an AGC adjustment before processing the received or sensing signal.

In wireless communication systems, the received signal may have an unpredictable signal power and varies over a wide dynamic range caused by multi-path fading channel and unwanted signals such as strong interferer signal. AGC may be a procedure for dynamically adjusting the AGC gain of the incoming signal to prevent the quantization error or saturation at the analog-to-digital converter (ADC) of the UE. Based on AGC, the received signal strength at the input of the ADCs may be boosted or reduced.

The example of diagram 400 includes transmission of AGC symbols at the start of each sensing transmission or cycle. A common AGC symbol 408, which may be similar to a sidelink AGC symbol, at the start of a CPI serves to indicate the received power over symbols where the sensing UEs (e.g., UE1 402, UE2 404) are frequency domain multiplexed (e.g., symbols 7 and 13 of slots #n 410 and #n+1 412, respectively, as shown in FIG. 4B). UE-dedicated AGC symbols 406 may be used to indicate the received power over symbols without frequency domain multiplexing. A UE-dedicated AGC symbol may indicate an AGC symbol for a particular UE rather than an AGC symbol used in common by each sensing UE, which may be referred to as a common AGC symbol. Selecting a UE-dedicated AGC symbols pattern may include some coordination between a UE and a network or between sensing UEs, such as knowledge of which devices will be transmitting and when the devices will transmit. In some aspects, the coordination information may be provided to the UEs by the network (e.g., network entity or network node). In some aspects, the coordination information may be provided by individual UEs, using a resource reservation scheme such as in mode-2 sidelink. In mode-2 sidelink communication, each UE selects their own resources for the sidelink transmission, e.g., rather than having the network assign resources as occurs in mode-1. After selecting the transmission resource, the UE may transmit sidelink control information (SCI) indicating the resources on which the UE intends to transmit. The information may be referred to as a resource reservation for the later sidelink transmission. The UEs receiving the SCI may use the resource reservation information to avoid selecting conflicting resources for their sidelink transmissions.

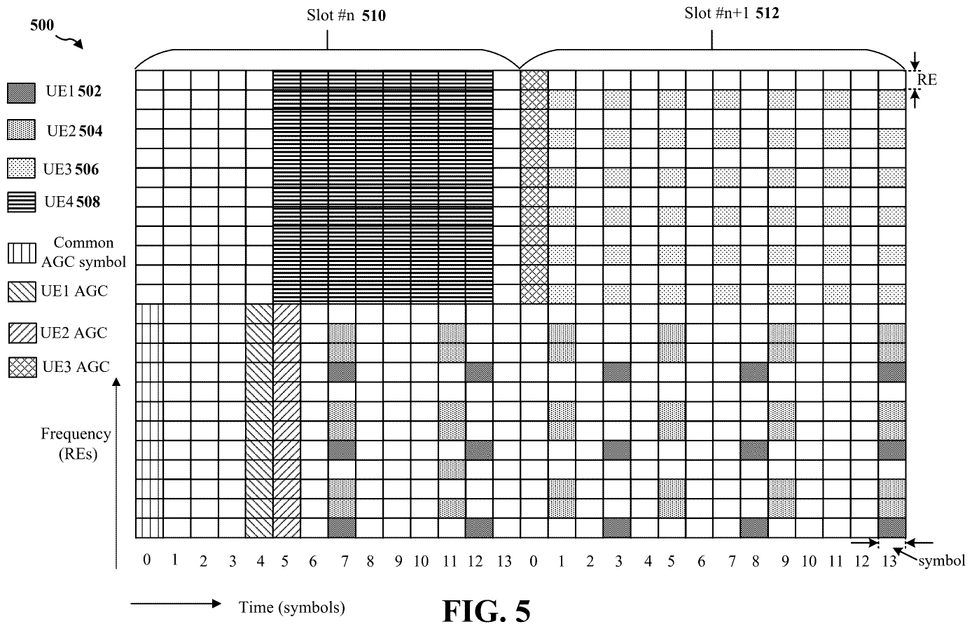

FIG. 5 is a diagram 500 of an example of where multiple sensing transmissions are not aligned. The diagram 500 of FIG. 5 may include multiple UEs (e.g., UE1 502, UE2 504, UE3 506) where frequency domain multiplexed sensing transmissions are not aligned and/or are frequency domain multiplexing with transmissions (e.g., uplink or sidelink) from one or more other UEs (e.g., UE4 508). For example, UE4 508 may perform a transmission (e.g., uplink transmission granted by the network) in slot #n 510 and UE3 506 may initiate a sensing transmission in a later slot (e.g., slot #n+1 512). The receive power level of sensing UEs (e.g., UE1 502, UE2 504) may not be constant within the CPI duration and the power readings based on the AGC symbols at the CPI start may not apply throughout.

Aspects presented herein provide a configuration for AGC patterns for minimizing AGC issues in time-interlaced sensing transmissions. For example, aspects of the present disclosure provide an improved sensing AGC symbol format to accommodate instances where frequency domain multiplexed sensing transmissions are not aligned and/or are frequency domain multiplexing with transmissions (e.g., uplink or sidelink).

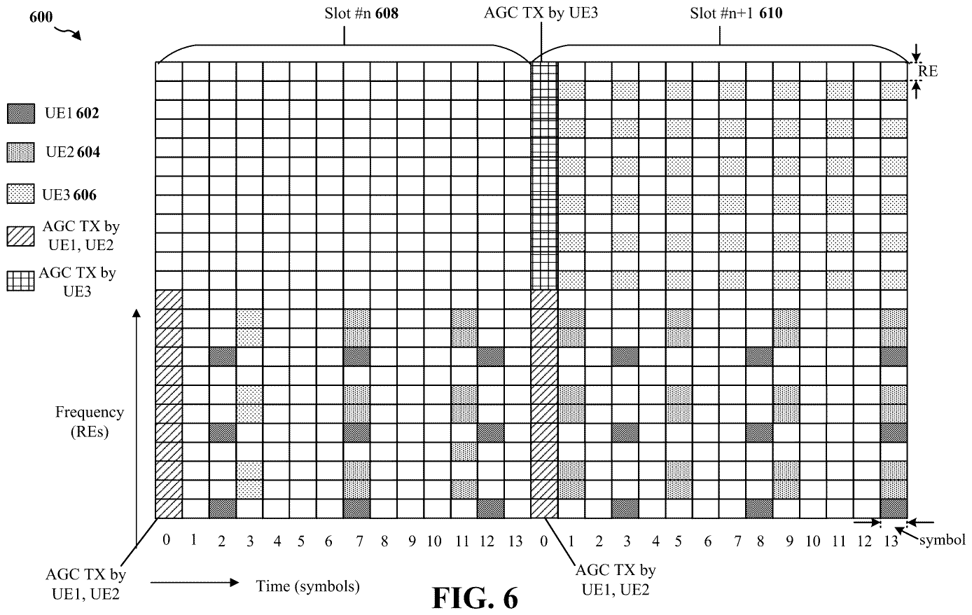

In some aspects, a sensing UE may have an understanding or knowledge, for each slot it performs sensing, of the receive power expected over the sensing symbols used in such slot. In some aspects, the UE that receives the sensing signal in order to perform sensing, whether or not the UE transmits the sensing transmission, may be referred to by various names such as a sensing UE, a sensing transmission receiving UE, a sensing transmission receiver, or a sensing receive UE, among other examples. A UE that transmits a sensing signal may be referred to by various names, such as a sensing UE, a sensing transmission transmitting UE, a sensing transmitter, or a sensing transmitting UE, among other examples. For example, when a UE performs a sensing interlace transmission with sensing symbols distributed over multiple slots, the UE may transmit an AGC symbol at the first symbol of each slot that contains at least one sensing symbol. In some aspects, if a slot comprises a first symbol as an sensing symbol, that symbol may be treated as an AGC symbol. This may allow for frequency domain multiplexing of sensing UEs without time-alignment and may also allow for non-sensing transmissions (e.g., uplink or sidelink communication transmissions) occurring within the CPI, in instances where such transmissions are transmitted over the AGC symbol. The AGC measurement at the beginning of the slot may correspond to the UEs that are transmitting within at least a part of the slot and may correspond to the symbols where the UEs are frequency domain multiplexed. In some aspects, a sensing transmission may or may not include UE-dedicated AGC symbols but may include common AGC symbol transmission at the start of every slot, as shown for example in diagram 600 of FIG. 6.

FIG. 6 is a diagram 600 of an example of a UE1 602 and UE2 604 performing sensing transmissions at slot #n 608 and slot #n+1 610. Both UEs transmit an AGC symbol at the first symbol (e.g., symbol 0) of each of the two slots. Diagram 600 also includes a UE3 606 that performs a sensing transmission at slot #n+1 610. UE3 606 transmits a respective AGC symbol at the first symbol (e.g., symbol 0) of slot #n+1 610. Each UE (e.g., UE1 602, UE2 604, UE3 606) may measure the power level of the AGC symbol in each slot. Each UE may also have an understanding or knowledge of the maximum total receive power expected over the sensing symbols of the corresponding UE's interlace within the slot.

In some aspects, transmission of the AGC symbols by the UE may be activated via at least one of RRC signaling (e.g., semi-static) and/or DCI (e.g., dynamic). In such instances, a DCI that grants a sensing transmission may override the RRC configuration for that transmission. For example, an RRC configuration may indicate that each sensing transmission include an AGC symbol per slot, while a DCI may provide a sensing transmission grant that comprises AGC transmission at the first slot (e.g., only at the first slot), such that the network (e.g., base station) is aware that no other transmissions will be frequency domain multiplexed with that particular sensing transmission, such that one AGC symbol at the first slot is sufficient.

In some aspects, such as when a communication transmission (e.g., uplink transmission or sidelink transmission) is performed by a UE within a slot, the UE may transmit over the first symbol of the slot where the sensing AGC symbol occurs. The UE transmitting over the first symbol of the slot where the sensing AGC symbol occurs may aid sensing UEs to measure the impact of such transmission to their receive power over such slot.

In some aspects, a DCI providing a PUSCH grant of type B with start symbol greater than 0 in a slot, may indicate for the UE to also transmit at symbol 0 over that same slot. For example, when the slot of the grant occurs, the UE performs a transmission over the first symbol of the slot in addition to the symbols allocated for the PUSCH by the type B mapping used in the grant. Although the example is described for DCI scheduling resources for PUSCH, the concept may be similarly applied for control signaling scheduling other communication, such as DCI scheduling resources for PUCCH, or a different channel or reference signal that does not allocate the first symbol of a slot for the PUCCH, channel, or reference signal, yet indicates for the UE to transmit in the first symbol of the slot, e.g., to enable sensing UEs to perform AGC for that slot.

In some aspects, a DCI providing a PSCCH/PSSCH grant over a sidelink resource pool configured with a start symbol greater than 0 in a slot (e.g., sl-startSymbol>0), may indicate that the UE is also to transmit at symbol 0 in that same slot. For example, when the slot of the grant (e.g., the slot in which the resources granted for PSCCH/PSSCH) occurs, the UE performs a transmission over the first symbol of the slot in addition to transmitting the PSCCH and/or PSSCH in the symbols allocated by the type B mapping used in the grant.

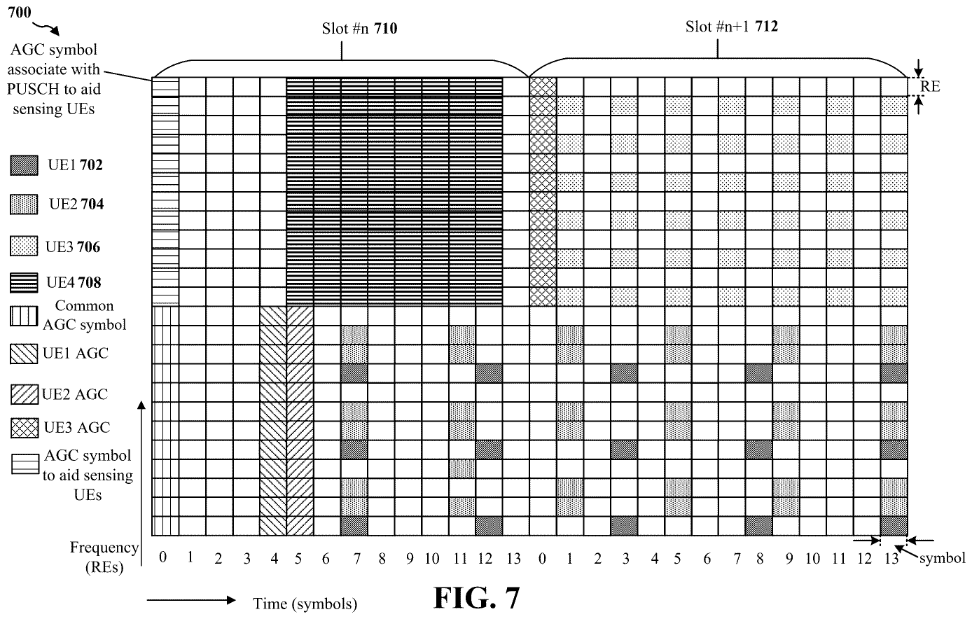

FIG. 7 is a diagram 700 of an example of multiplexing sensing and communication transmissions. Diagram 700 may include UE1 702, UE2 704, UE3 706, and UE4 708, where UE4 708 receives a PUSCH grant for transmission in slot #n 710, symbols 5-12 where a DCI indicates transmission of a first AGC symbol in the slot. UE1 702 and UE2 704 perform sensing transmissions at slot #n 710 and slot #n+1 712. Both UEs transmit an AGC symbol at the first symbol (e.g., symbol 0) of each of the two slots. UE3 706 performs a sensing transmission at slot #n+1 712 and transmits a respective AGC symbol at the first symbol (e.g., symbol 0) of slot #n+1 712. Each UE (e.g., UE1 702, UE2 704, UE3 706) may measure the power level of the AGC symbol in each slot.

In some aspects, an extra first symbol of the slot transmission, as discussed in connection with FIG. 6 or 7, may be transmitted using the same power as the nominal symbols of the corresponding transmission in that slot. In such instances the transmitted signal may be configured (e.g., signaled to the UE) or defined (e.g., defined in a wireless standard or otherwise known in advance by the UEs), a repetition of the first symbol of the nominal transmission, obtained by rate matching of data over an extended number of transmit resources, or may be arbitrary.

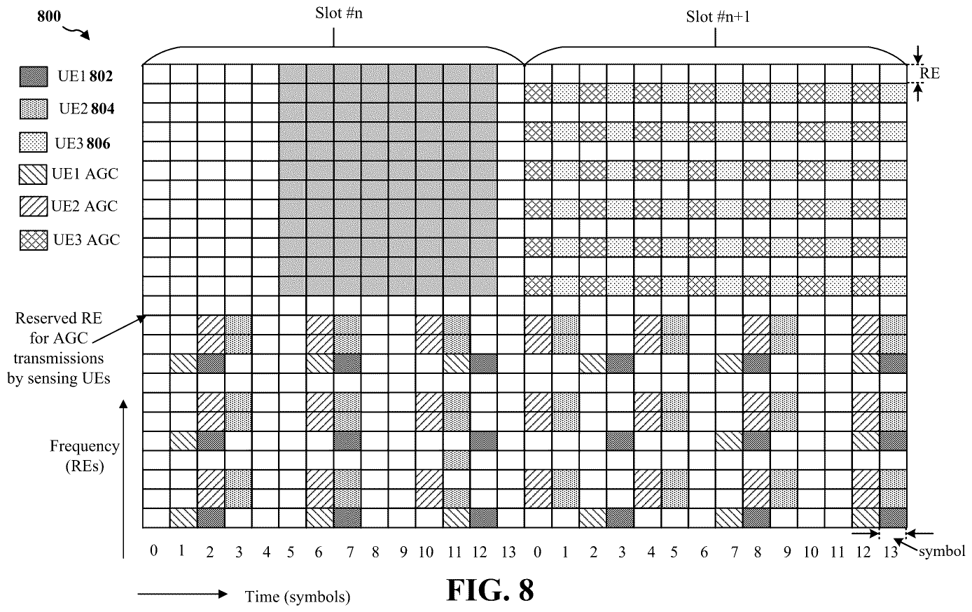

In some aspects, a UE may perform a slot-level AGC adjustment based on a measurement of the received power from the transmissions of the active UEs that are active in a given slot. In some aspects, the transmissions in the first symbol (e.g. symbol 0 of the slot) from the active UEs may be frequency domain multiplexed, and may lead to reduced operations. For example, if multiple UEs are transmitting their sensing symbols over dedicated symbols of the same slot such that no frequency domain multiplexing occurs in the slot, with each of the UEs transmitting at the first AGC symbol of the slot, the AGCs of the receivers may be adjusted to that power level, while the sensing transmissions may be performed without any frequency domain multiplexing. The aspects of the present disclosure help to avoid such instances and identify an improved AGC state for each sensing symbol or burst of consecutive sensing symbols transmitted. For example, if a UE performs a sensing transmission using an interlace pattern, the UE may prepend to each sensing, isolated symbol or isolated burst of contiguous sensing symbols an AGC symbol transmission using the same frequency pattern as the corresponding sensing symbols pattern. For example, the UE performing a sensing transmission using an interlace pattern may transmit the AGC symbol prior to each isolated symbol or isolated burst of contiguous sensing symbols, as shown for example in diagram 800 of FIG. 8. The example in FIG. 8 illustrates an AGC symbol, e.g., a transmission in an AGC symbol, having a finer granularity than the examples in FIGS. 5-7 (e.g., a granularity prior to each isolated symbol or set of contiguous symbols rather than per slot) Diagram 800 includes UE1 802, UE2 804, and UE3 806, where each sensing symbol or burst of contiguous sensing symbols of sensing transmissions are preceded by an AGC transmission using the same frequency pattern.

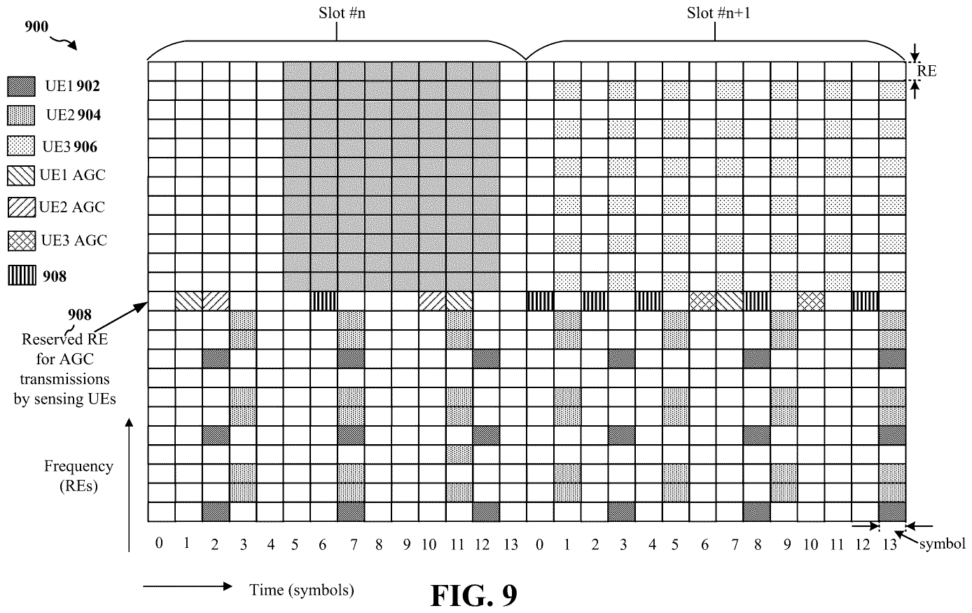

In some aspects, if a UE performs a sensing transmission using an interlace pattern, the UE may prepend to each active isolated symbol or isolated burst of contiguous sensing symbols an AGC symbol transmission over a cell-specific dedicated set of REs used for sensing transmissions. For example, the UE performing a sensing transmission using an interlace pattern may transmit the AGC symbol prior to a dedicated set of REs used for each of the sensing transmissions, as shown for example in diagram 900 of FIG. 9. This may allow for a reduction in overhead of the additional AGC symbols, of diagram 800 of FIG. 8. In some aspects, the REs may be configured for the UE via RRC signaling. Diagram 900 of FIG. 9 includes UE1 902, UE2 904, and UE3 906, where REs 908 are reserved for AGC transmissions of sensing UEs. The reserved REs may correspond to sensing AGC resources where more than one UE transmits an AGC signal.

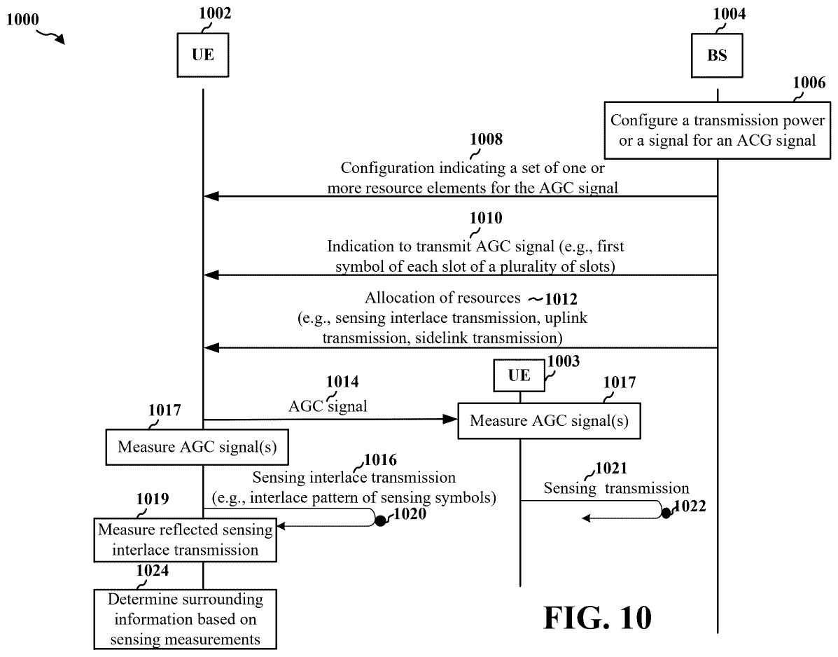

FIG. 10 is a call flow diagram 1000 of signaling between a UE 1002 and a base station 1004. The base station 1004 may be configured to provide at least one cell. The UE 1002 may be configured to communicate with the base station 1004. For example, in the context of FIG. 1, the base station 1004 may correspond to base station 102 and the UE 1002 may correspond to at least UE 104. In another example, in the context of FIG. 3, the base station 1004 may correspond to base station 310 and the UE 1002 may correspond to UE 350.

At 1006, the base station 1004 may configure at least one of a transmission power or a signal for an AGC signal. The base station may configure at least one of the transmission power or the signal for the AGC signal for the UE 1002. The configuration of the transmission power or the signal for the AGC signal may be part of a sensing interlace transmission procedure for the UE.

At 1008, the base station 1004 may provide may provide a configuration indicating a set of one or more resource elements dedicated for the AGC signal. The base station may provide, to the UE 1002, the configuration indicating the set of the one or more resource elements dedicated for the AGC signal. The UE 1002 may receive the configuration indicating the set of the one or more resource elements dedicated for the AGC signal from the base station 1004.

At 1010, the base station 1004 may provide an indication for the UE 1002 to transmit an AGC signal in a first symbol of each slot of a plurality of slots comprising at least one of an sensing symbol of a sensing interlace transmission, an uplink transmission having a starting symbol allocated after the first symbol of a slot. The UE 1002 may receive the indication to transmit the AGC signal from the base station 1004. The base station may provide the indication for the UE to transmit the AGC signal in the first symbol of each slot of the plurality of slots comprising a sidelink transmission having a starting symbol allocated after the first symbol of a slot. The base station may provide the indication for the UE to transmit the AGC signal in the first symbol of each slot of the plurality of slots prior to each contiguous set of one or more sensing symbols of the sensing interlace transmission. In some aspects, to provide the indication for the UE may include providing the indication to transmit the AGC signal in the first symbol of each slot of the plurality of slots comprising at least one active symbol of the sensing interlace transmission, and the allocation of resources is for the sensing interlace transmission comprising the sensing symbols over the plurality of slots. In some aspects, the indication may be included in at least one of RRC signaling, DCI, or MAC-CE. In some aspects, to provide the indication for the UE may include providing the indication to transmit the AGC signal in the first symbol of the slot comprising the at least one sensing symbol of the uplink transmission having the starting symbol allocated after the first symbol of the slot, and the allocation of the resources is for the uplink transmission having the starting symbol allocated after the first symbol of the slot. In some aspects, to provide the indication for the UE may include providing the indication to transmit the AGC signal in the first symbol of the slot comprising the at least one sensing symbol of the sidelink transmission having the starting symbol allocated after the first symbol of the slot, and the allocation of the resources is for the sidelink transmission having the starting symbol allocated after the first symbol of the slot. In some aspects, to provide the indication for the UE may include providing the indication to transmit the AGC signal prior to each contiguous set of one or more sensing symbols of the sensing interlace transmission, and the allocation of resources is for the sensing interlace transmission comprising the sensing symbols over the one or more slots.

At 1012, the base station 1004 may provide an allocation of resources for at least one of the sensing interlace transmission comprising sensing symbols over one or more slots, the uplink transmission starting after the first symbol of the slot, or the sidelink transmission starting after the first symbol of the slot. The base station 1004 may provide the allocation of resources to the UE 1002. The UE 1002 may receive the allocation of resources from the base station 1004.

At 1014, the UE 1002 may transmit an AGC signal in a first symbol of each slot of the plurality of slots comprising at least one sensing symbol of the sensing interlace transmission. The UE may transmit the AGC signal prior to each contiguous set of one or more sensing symbols of the sensing interlace transmission. In some aspects, transmission of the AGC signal may include transmitting the AGC signal in the first symbol of each slot of the plurality of slots comprising the at least one sensing symbol of the sensing interlace transmission. In some aspects, transmission of the AGC signal in the first symbol may include transmitting the AGC signal at a transmission power that is common to the sensing interlace transmission in other symbols within a same slot as the AGC signal. The AGC signal may comprise at least one of a configured signal, a defined signal, a repetition of a first symbol of the sensing interlace transmission (which may be referred to as a first sensing transmission symbol), a signal based on rate matching of data over an extended number transmit resources, or a UE selected signal. In some aspects, transmission of the AGC signal may include transmitting the AGC signal prior to each contiguous set of one or more sensing symbols of the sensing interlace transmission. In some aspects, the AGC symbol may be included with each of the at least one sensing symbol. The AGC symbol may be transmitted using a same frequency pattern as each of the at least one sensing symbol within a same slot. In some aspects, transmission of the AGC signal may include transmitting the AGC signal in resource elements spanning a frequency range of the sensing interlace transmission.

As shown at 1017, the UE 1002 may perform measurements for AGC, including measuring the AGC signals received from other UEs. For example, FIG. 10 illustrates that a second UE 1003 may measure the AGC signal from the UE 1002. Similarly, the UE 1002, may measure an AGC signal, at 1017, from the UE 1003 and/or from other UEs that are not illustrated.

At 1016, the UE 1002 may transmit a sensing interlace transmission. The UE may transmit the sensing interlace transmission comprising an interlace pattern of sensing symbols over a plurality of slots. The UE may transmit the sensing interlace transmission as part of a sensing interlace transmission procedure.

The UE 1002 may measure, at 1019, the reflected sensing signal to determine information about the UE's surroundings, at 1024, e.g., as described in connection with FIG. 4A. The determination, and/or measurement, may be based on the AGC performed using measurements performed at 1017. For example, the UE 1002 may detect the presence, location, and/or movement of an object 1020 that reflects sensing transmission. Similarly, the UE 1003 may transmit a sensing transmission 1021, and using the measured AGC, may detect an object 1022 based on the measurements of the reflected sensing transmission.

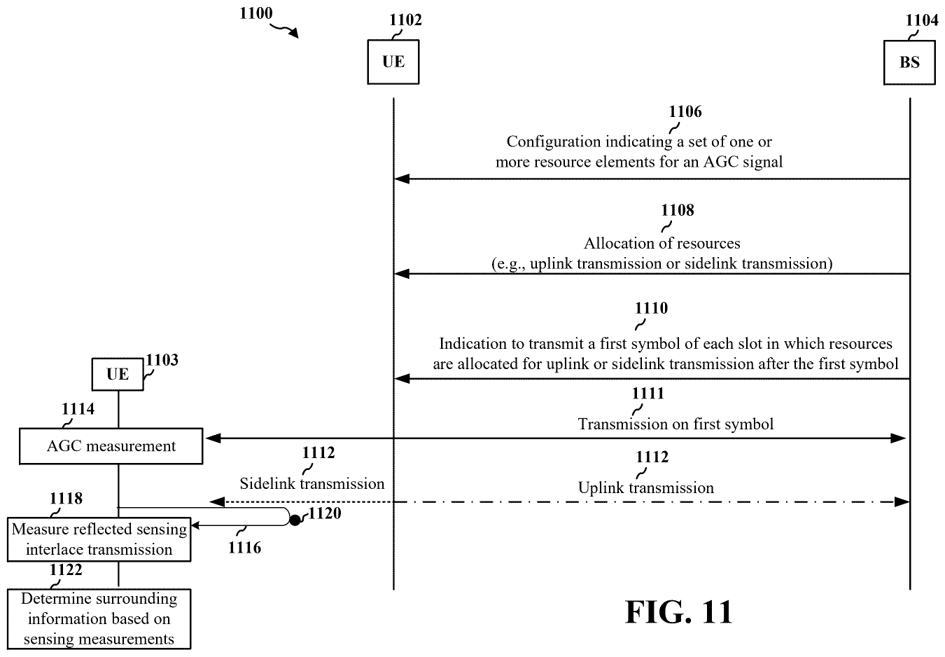

FIG. 11 is a call flow diagram 1100 of signaling between a UE 1102 and a base station 1104. The base station 1104 may be configured to provide at least one cell. The UE 1102 may be configured to communicate with the base station 1104. For example, in the context of FIG. 1, the base station 1104 may correspond to base station 102 and the UE 1102 may correspond to at least UE 104. In another example, in the context of FIG. 3, the base station 1104 may correspond to base station 310 and the UE 1102 may correspond to UE 350.

In some aspects, at 1106, the base station 1104 may provide a configuration indicating the set of the one or more resource elements for an AGC signal. The base station 1104 may provide the configuration indicating the set of the one or more resource elements for the AGC signal to the UE 1102. The UE 1102 may receive the configuration indicating the set of the one or more resource elements for the AGC signal from the base station 1104. In some aspects, transmission of the first symbol, by the UE 1102, may include transmitting in a set of one or more resource elements dedicated for AGC.

At 1108, the base station 1104 may provide an allocation of resources. The base station 1104 may provide the allocation of resources to the UE 1102. The UE 1102 may receive the allocation of resources from the base station 1104. The allocation of resources may be configured for an uplink transmission or a sidelink transmission with a starting symbol after a first symbol in a slot.

At 1110, the base station 1104 may provide an indication to transmit a first symbol of each slot in which resources are allocated for an uplink transmission or a sidelink transmission beginning after the first symbol of the slot. In some aspects, the control signaling may be provided in control signaling that provides the resource allocation. In other aspects, the indication may be separate from the resource allocation. The base station 1104 may provide the indication to transmit the first symbol of each slot to the UE 1102. The UE 1102 may receive the indication to transmit the first symbol of each slot from the base station 1104. The base station may provide the indication to the UE to transmit the first symbol of each slot via at least one of RRC signaling, DCI, or MAC-CE.

At 1112, the UE 1102 may transmit an uplink transmission or a sidelink transmission. In some aspects, the UE 1102 may transmit the uplink transmission to the base station 1104. In some aspects, the UE 1102 may transmit the sidelink transmission to another UE (not shown). The UE 1102 may transmit in a first symbol of the slot, as shown at 1111, corresponding to the uplink transmission or the sidelink transmission. In some aspects, the UE may transmit at least one of the AGC signal or a portion of communication for the uplink transmission or the sidelink transmission in the first symbol of the slot. The UE may transmit the AGC signal that may comprise at least one of a configured signal, a defined signal, a repetition of a first symbol of the uplink transmission or the sidelink transmission, a signal based on rate matching of data over an extended number transmit resources, or a UE selected signal. In some aspects, transmitting in the first symbol includes transmitting in resource elements spanning a frequency range of the uplink transmission or the sidelink transmission.

As shown at 1114, a UE 1103 may perform measurements of the signal transmitted in the first symbol for AGC relating sensing. For example, the UE 1103 may correspond to the UE 1002 or 1003 in FIG. 10.

At 1116, the UE 1103 may transmit a sensing transmission, which may include a sensing interlace transmission, e.g., as described in connection with any of FIGS. 5-10. The UE may transmit the sensing interlace transmission comprising an interlace pattern of sensing symbols over a plurality of slots. The UE may transmit the sensing interlace transmission as part of a sensing interlace transmission procedure.

The UE 1103 may measure, at 1118, the reflected sensing signal to determine information about the UE's surroundings, at 1122, e.g., as described in connection with FIG. 4A. The determination, and/or measurement, may be based on the AGC performed using measurements performed at 1114. For example, the UE 1103 may detect the presence, location, and/or movement of an object 1120 that reflects sensing transmission.

The transmission from the UE 1102 in the first symbol, e.g., at 1111, enables the UE 1103, to perform a more accurate AGC and improve its sensing measurements and determinations based on the improved AGC.

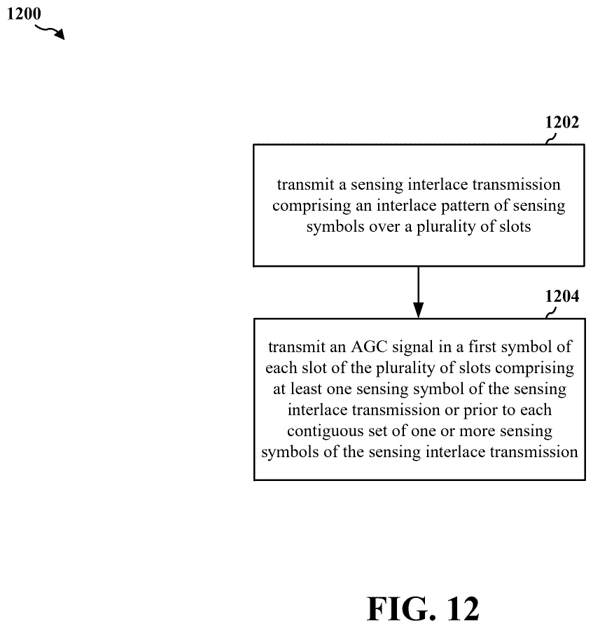

FIG. 12 is a flowchart 1200 of a method of wireless communication. The method may be performed by a UE (e.g., the UE 104, 350, 1002; the apparatus 1404). One or more of the illustrated operations may be omitted, transposed, or contemporaneous. The method may allow a UE to perform an enhanced sensing interlace transmission procedure.

At 1202, the UE may transmit a sensing interlace transmission. For example, 1202 may be performed by the interlace transmission component 198 of apparatus 1404. The UE may transmit the sensing interlace transmission comprising an interlace pattern of sensing symbols over a plurality of slots. The UE may transmit the sensing interlace transmission as part of a sensing interlace transmission procedure. FIG. 10 and FIG. 11 illustrate examples of UE 1002, 1003, and 1103 transmitting sensing signals, at 1016, 1021, and 1116. The sensing interlace transmissions may include any of the aspects described in connection with FIG. 4A-11, for example.

At 1204, the UE may transmit an AGC signal. For example, 1204 may be performed by the interlace transmission component 198 of apparatus 1404. The UE may transmit the AGC signal in a first symbol of each slot of the plurality of slots comprising at least one sensing symbol of the sensing interlace transmission. The UE may transmit the AGC signal prior to each contiguous set of one or more sensing symbols of the sensing interlace transmission. In some aspects, transmission of the AGC signal may include transmitting the AGC signal in the first symbol of each slot of the plurality of slots comprising the at least one sensing symbol of the sensing interlace transmission. In some aspects, transmission of the AGC signal in the first symbol may include transmitting the AGC signal at a transmission power that is common to the sensing interlace transmission in other symbols within a same slot as the AGC signal. The AGC signal may comprise at least one of a configured signal, a defined signal, a repetition of a first symbol of the sensing interlace transmission (which may be referred to as a first sensing transmission symbol), a signal based on rate matching of data over an extended number transmit resources, or a UE selected signal. In some aspects, transmission of the AGC signal may include transmitting the AGC signal prior to each contiguous set of one or more sensing symbols of the sensing interlace transmission. In some aspects, the AGC symbol may be included with each of the at least one sensing symbol. The AGC symbol may be transmitted using a same frequency pattern as each of the at least one sensing symbol within a same slot. In some aspects, transmission of the AGC signal may include transmitting the AGC signal in resource elements spanning a frequency range of the sensing interlace transmission.

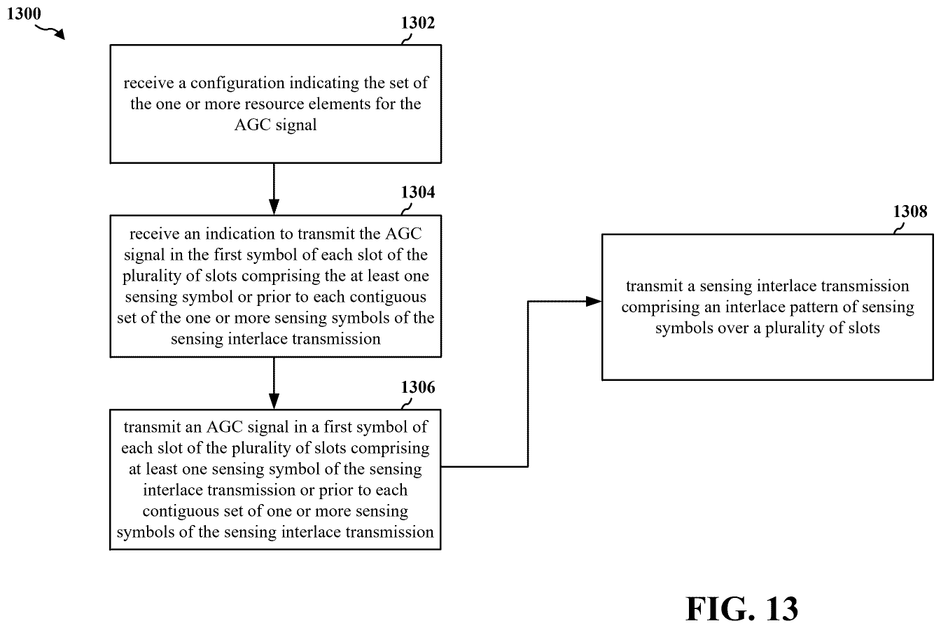

FIG. 13 is a flowchart 1300 of a method of wireless communication. The method may be performed by a UE (e.g., the UE 104, 350, 1002; the apparatus 1404). One or more of the illustrated operations may be omitted, transposed, or contemporaneous. The method may allow a UE to perform an enhanced sensing interlace transmission procedure.

At 1302, the UE may receive a configuration indicating a set of one or more resource elements for the AGC signal. For example, 1302 may be performed by the interlace transmission component 198 of apparatus 1404. In some aspects, transmission of the AGC signal may include transmitting the AGC signal in a set of one or more resource elements dedicated for the AGC signal. The UE may receive the configuration indicating the set of the one or more resource elements for the AGC signal from the network entity. FIG. 10 illustrates an example of a UE 1002 receiving a configuration, at 1008, from a network node.

At 1304, the UE may receive an indication to transmit an AGC signal. For example, 1304 may be performed by the interlace transmission component 198 of apparatus 1404. The UE may receive the indication to transmit the AGC signal in the first symbol of each slot of the plurality of slots comprising the at least one sensing symbol or prior to each contiguous set of the one or more sensing symbols of the sensing interlace transmission. The UE may receive the indication to transmit the AGC signal via at least one of RRC signaling or MAC-CE. The UE may receive the indication to transmit the AGC signal from a network entity. FIG. 10 illustrates an example of a UE 1002 receiving an indication, at 1010, from a network node.

At 1306, the UE may transmit an AGC signal. For example, 1308 may be performed by the interlace transmission component 198 of apparatus 1404. FIG. 10 illustrate an example of UE 1002 transmitting an AGC signal 1014. The AGC signal may be based on a pattern, e.g., as described in connection with any of FIGS. 5-9, for example. The UE may transmit the AGC signal in a first symbol of each slot of the plurality of slots comprising at least one sensing symbol of the sensing interlace transmission. The UE may transmit the AGC signal prior to each contiguous set of one or more sensing symbols of the sensing interlace transmission. In some aspects, transmission of the AGC signal may include transmitting the AGC signal in the first symbol of each slot of the plurality of slots comprising the at least one sensing symbol of the sensing interlace transmission. In some aspects, transmission of the AGC signal in the first symbol may include transmitting the AGC signal at a transmission power that is common to the sensing interlace transmission in other symbols within a same slot as the AGC signal. The AGC signal may comprise at least one of a configured signal, a defined signal, a repetition of a first symbol of the sensing interlace transmission (which may be referred to as a first sensing transmission symbol), a signal based on rate matching of data over an extended number transmit resources, or a UE selected signal. In some aspects, transmission of the AGC signal may include transmitting the AGC signal prior to each contiguous set of one or more sensing symbols of the sensing interlace transmission. In some aspects, the AGC symbol may be included with each of the at least one sensing symbol. The AGC symbol may be transmitted using a same frequency pattern as each of the at least one sensing symbol within a same slot. In some aspects, transmission of the AGC signal may include transmitting the AGC signal in resource elements spanning a frequency range of the sensing interlace transmission.

At 1308, the UE may transmit a sensing interlace transmission. For example, 1306 may be performed by the interlace transmission component 198 of apparatus 1404. The UE may transmit the sensing interlace transmission comprising an interlace pattern of sensing symbols over a plurality of slots. The UE may transmit the sensing interlace transmission as part of a sensing interlace transmission procedure. FIG. 10 and FIG. 11 illustrate examples of UE 1002, 1003, and 1103 transmitting sensing signals, at 1016, 1021, and 1116. The sensing interlace transmissions may include any of the aspects described in connection with FIG. 4A-11, for example.

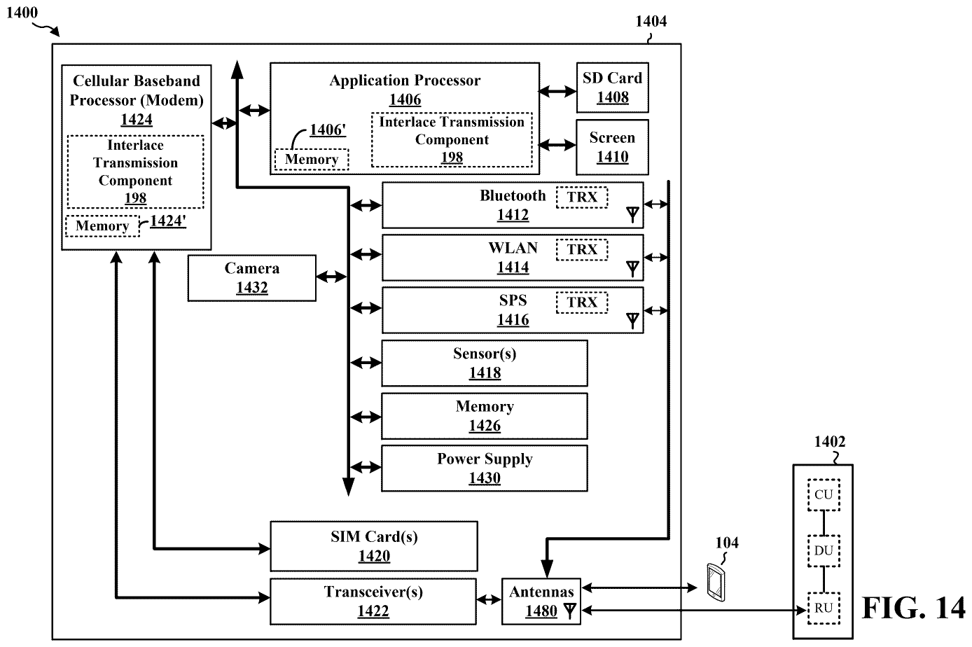

FIG. 14 is a diagram 1400 illustrating an example of a hardware implementation for an apparatus 1404. The apparatus 1404 may be a UE, a component of a UE, or may implement UE functionality. The apparatus 1404 may correspond to the UE 104, 350, 1002, and/or 1102. In some aspects, the apparatus 1404 may include at least one cellular baseband processor 1424 (also referred to as a modem) coupled to one or more transceivers 1422 (e.g., cellular RF transceiver). The cellular baseband processor(s) 1424 may include on-chip memory 1424′. In some aspects, the apparatus 1404 may further include one or more subscriber identity modules (SIM) cards 1420 and at least one application processor 1406 coupled to a secure digital (SD) card 1408 and a screen 1410. The application processor(s) 1406 may include on-chip memory 1406′. In some aspects, the apparatus 1404 may further include a Bluetooth module 1412, a WLAN module 1414, an SPS module 1416 (e.g., GNSS module), one or more sensor modules 1418 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1426, a power supply 1430, and/or a camera 1432. The Bluetooth module 1412, the WLAN module 1414, and the SPS module 1416 may include an on-chip transceiver (TRX) (or in some cases, just a receiver (RX)). The Bluetooth module 1412, the WLAN module 1414, and the SPS module 1416 may include their own dedicated antennas and/or utilize the antennas 1480 for communication. The cellular baseband processor(s) 1424 communicates through the transceiver(s) 1422 via one or more antennas 1480 with the UE 104 and/or with an RU associated with a network entity 1402. The cellular baseband processor(s) 1424 and the application processor(s) 1406 may each include at least one computer-readable medium/memory 1424′, 1406′, respectively. The additional memory modules 1426 may also be considered a computer-readable medium/memory. Each computer-readable medium/memory 1424′, 1406′, 1426 may be non-transitory. The cellular baseband processor(s) 1424 and the application processor(s) 1406 are each responsible for general processing, including the execution of software stored on the computer-readable medium/memory. The software, when executed by the cellular baseband processor(s) 1424/application processor(s) 1406, causes the cellular baseband processor(s) 1424/application processor(s) 1406 to perform the various functions described supra. The computer-readable medium/memory may also be used for storing data that is manipulated by the cellular baseband processor(s) 1424/application processor(s) 1406 when executing software. The cellular baseband processor(s) 1424/application processor(s) 1406 may be a component of the UE 350 and may include the memory 360 and/or at least one of the TX processor 368, the RX processor 356, and the controller/processor 359. In one configuration, the apparatus 1404 may be at least one processor chip (modem and/or application) and include just the cellular baseband processor(s) 1424 and/or the application processor(s) 1406, and in another configuration, the apparatus 1404 may be the entire UE (e.g., see 350 of FIG. 3) and include the additional modules of the apparatus 1404.

As discussed supra, the interlace transmission component 198 may be configured to transmit a sensing interlace transmission comprising an interlace pattern of sensing symbols over a plurality of slots; and transmit an AGC signal in a first symbol of each slot of the plurality of slots comprising at least one sensing symbol of the sensing interlace transmission or prior to each contiguous set of one or more sensing symbols of the sensing interlace transmission. The interlace transmission component 198 may be configured to receive, via at least one of RRC signaling, DCI, or MAC-CE, an indication to transmit the AGC signal in the first symbol of each slot of the plurality of slots comprising the at least one symbol or prior to each contiguous set of the one or more sensing symbols of the sensing interlace transmission. The interlace transmission component 198 may be configured to receive a configuration indicating the set of the one or more resource elements for the AGC signal. The interlace transmission component may be further configured to perform any of the aspects described in connection with the flowcharts in FIG. 12, 13, 15, or 16, and/or the aspects performed by the UEs in the communication flow diagrams in FIGS. 10 and/or 11. The interlace transmission component 198 may be within the cellular baseband processor(s) 1424, the application processor(s) 1406, or both the cellular baseband processor(s) 1424 and the application processor(s) 1406. The interlace transmission component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the function individually or in combination. As shown, the apparatus 1404 may include a variety of components configured for various functions. In one configuration, the apparatus 1404, and in particular the cellular baseband processor(s) 1424 and/or the application processor(s) 1406, includes means for transmitting a sensing interlace transmission comprising an interlace pattern of sensing symbols over a plurality of slots. The apparatus includes means for transmitting an AGC signal in a first symbol of each slot of the plurality of slots comprising at least one sensing symbol of the sensing interlace transmission or prior to each contiguous set of one or more sensing symbols of the sensing interlace transmission. The apparatus further includes means for receiving, via at least one of RRC signaling, DCI, or MAC-CE, an indication to transmit the AGC signal in the first symbol of each slot of the plurality of slots comprising the at least one sensing symbol or prior to each contiguous set of the one or more sensing symbols of the sensing interlace transmission. The apparatus further includes means for receiving a configuration indicating the set of the one or more resource elements for the AGC signal. The apparatus may further include means for performing any of the aspects described in connection with the flowcharts in FIG. 12, 13, 15, or 16, and/or the aspects performed by the UEs in the communication flow diagrams in FIGS. 10 and/or 11. The means may be the interlace transmission component 198 of the apparatus 1404 configured to perform the functions recited by the means. As described supra, the apparatus 1404 may include the TX processor 368, the RX processor 356, and the controller/processor 359. As such, in one configuration, the means may be the TX processor 368, the RX processor 356, and/or the controller/processor 359 configured to perform the functions recited by the means.

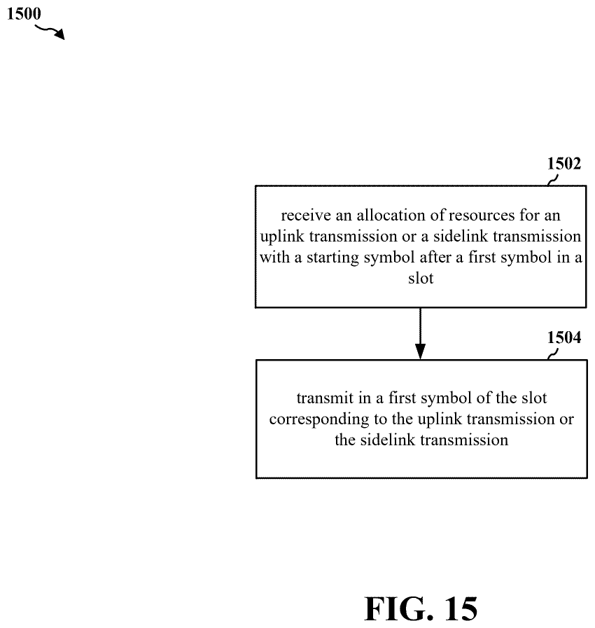

FIG. 15 is a flowchart 1500 of a method of wireless communication. The method may be performed by a UE (e.g., the UE 104, 350, 1102; the apparatus 1704). One or more of the illustrated operations may be omitted, transposed, or contemporaneous. The method may assist sensing UEs by transmitting over a symbol of a slot where a sensing AGC symbol occurs.

At 1502, the UE may receive an allocation of resources. FIG. 11 illustrates an example of a UE 1102 receiving a resource allocation from a base station 1104, as an example. For example, 1502 may be performed by the AGC transmission component 197 of apparatus 1704. The UE may receive the allocation of resources for an uplink transmission or a sidelink transmission with a starting symbol after a first symbol in a slot. The UE may receive the allocation of resources from a network entity.

At 1504, the UE may transmit in a first symbol of the slot corresponding to the uplink transmission or the sidelink transmission, which may be referred to as a first uplink or sidelink symbol of the slot. FIG. 11 illustrates an example of the UE 1102 transmitting in the first symbol, at 1111. For example, FIG. 7 illustrates an example of a transmission in a first symbol. For example, 1504 may be performed by the AGC transmission component 197 of apparatus 1704. In some aspects, the UE may transmit at least one of an AGC signal or a portion of communication for the uplink transmission or the sidelink transmission in the first symbol of the slot. The UE may transmit the AGC signal that may comprise at least one of a configured signal, a defined signal, a repetition of a first symbol of the uplink transmission or the sidelink transmission, a signal based on rate matching of data over an extended number transmit resources, or a UE selected signal. In some aspects, transmitting in the first symbol includes transmitting in resource elements spanning a frequency range of the uplink transmission or the sidelink transmission.

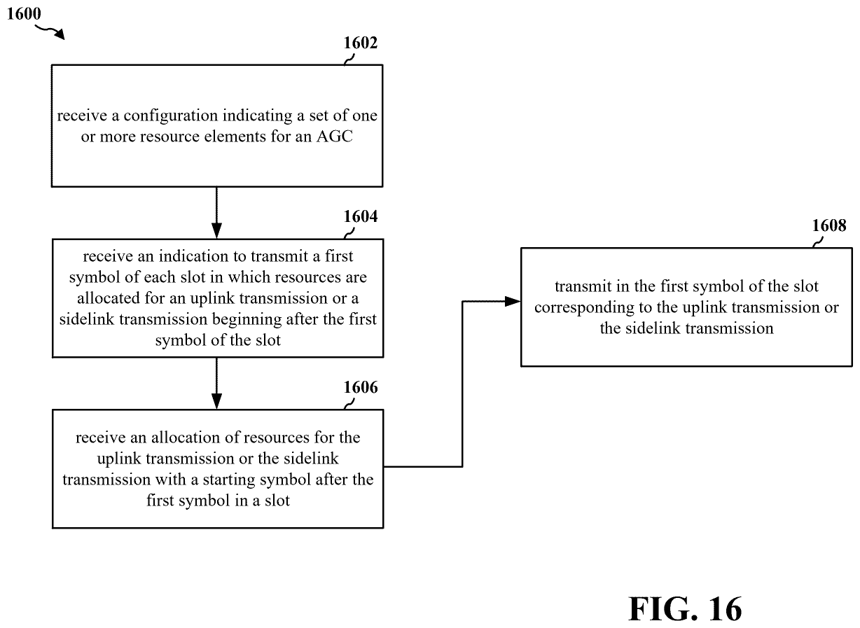

FIG. 16 is a flowchart 1600 of a method of wireless communication. The method may be performed by a UE (e.g., the UE 104, 350, 1102; the apparatus 1704). One or more of the illustrated operations may be omitted, transposed, or contemporaneous. The method may assist sensing UEs by transmitting over a symbol of a slot where a sensing AGC symbol occurs.

At 1602, the UE may receive a configuration indicating the set of the one or more resource elements for the AGC. FIG. 11 illustrates an example of a UE 1102 receiving, at 1106, a configuration from a base station 1104. For example, 1602 may be performed by the AGC transmission component 197 of apparatus 1704. In some aspects, transmitting in the first symbol may include transmitting in a set of one or more resource elements dedicated for AGC. The UE may receive the configuration indicating the set of the one or more resource elements for the AGC from the network entity.

At 1604, the UE may receive an indication to transmit a first symbol of slots. For example, 1604 may be performed by the AGC transmission component 197 of apparatus 1704. For example, FIG. 11 illustrates an example of a UE 1102 receiving an indication from a base station 1104, at 1110. The UE may receive the indication to transmit a first symbol of each slot in which resources are allocated for an uplink transmission or a sidelink transmission beginning after the first symbol of the slot. The UE may receive the indication to transmit the first symbol of each slot from a network entity. The UE may receive the indication to transmit the first symbol of each slot via at least one of RRC signaling, DCI, or MAC-CE.

At 1606, the UE may receive an allocation of resources. For example, 1606 may be performed by the AGC transmission component 197 of apparatus 1704. FIG. 11 illustrates an example of a UE 1102 receiving a resource allocation, at 1108, from a base station 1104, as an example. The UE may receive the allocation of resources for an uplink transmission or a sidelink transmission with a starting symbol after a first symbol in a slot. The UE may receive the allocation of resources from a network entity. In some aspects, the indication may be comprised in control signaling that provides the resource allocation.

At 1608, the UE may transmit in a first symbol of the slot corresponding to the uplink transmission or the sidelink transmission, which may be referred to as a first uplink or sidelink symbol of the slot. FIG. 11 illustrates an example of the UE 1102 transmitting in the first symbol, at 1111. For example, FIG. 7 illustrates an example of a transmission in a first symbol. For example, 1608 may be performed by the AGC transmission component 197 of apparatus 1704. In some aspects, the UE may transmit at least one of an AGC signal or a portion of communication for the uplink transmission or the sidelink transmission in the first symbol of the slot. The UE may transmit the AGC signal that may comprise at least one of a configured signal, a defined signal, a repetition of a first symbol of the uplink transmission or the sidelink transmission, a signal based on rate matching of data over an extended number transmit resources, or a UE selected signal. In some aspects, transmitting in the first symbol includes transmitting in resource elements spanning a frequency range of the uplink transmission or the sidelink transmission.

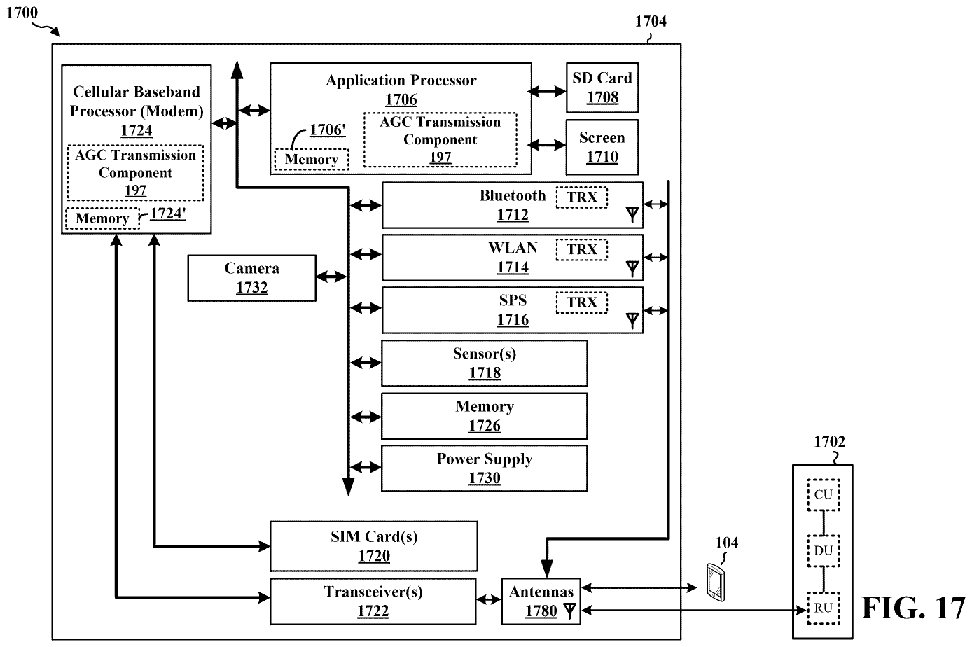

FIG. 17 is a diagram 1700 illustrating an example of a hardware implementation for an apparatus 1704. The apparatus 1704 may be a UE, a component of a UE, or may implement UE functionality. The apparatus may correspond to the UE 104, 350, 1102, and/or 1102. In some aspects, the apparatus 1704 may include at least one cellular baseband processor 1724 (also referred to as a modem) coupled to one or more transceivers 1722 (e.g., cellular RF transceiver). The cellular baseband processor 1724 may include on-chip memory 1724′. In some aspects, the apparatus 1704 may further include one or more subscriber identity modules (SIM) cards 1720 and at least one application processor 1706 coupled to a secure digital (SD) card 1708 and a screen 1710. The application processor(s) 1706 may include on-chip memory 1706′. In some aspects, the apparatus 1704 may further include a Bluetooth module 1712, a WLAN module 1714, an SPS module 1716 (e.g., GNSS module), one or more sensor modules 1718 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1726, a power supply 1730, and/or a camera 1732. The Bluetooth module 1712, the WLAN module 1714, and the SPS module 1716 may include an on-chip transceiver (TRX) (or in some cases, just a receiver (RX)). The Bluetooth module 1712, the WLAN module 1714, and the SPS module 1716 may include their own dedicated antennas and/or utilize the antennas 1780 for communication. The cellular baseband processor(s) 1724 communicates through the transceiver(s) 1722 via one or more antennas 1780 with the UE 104 and/or with an RU associated with a network entity 1702. The cellular baseband processor(s) 1724 and the application processor(s) 1706 may each include at least one computer-readable medium/memory 1724′, 1706′, respectively. The additional memory modules 1726 may also be considered a computer-readable medium/memory. Each computer-readable medium/memory 1724′, 1706′, 1726 may be non-transitory. The cellular baseband processor(s) 1724 and the application processor(s) 1706 are each responsible for general processing, including the execution of software stored on the computer-readable medium/memory. The software, when executed by the cellular baseband processor(s) 1724/application processor(s) 1706, causes the cellular baseband processor(s) 1724/application processor(s) 1706 to perform the various functions described supra. The computer-readable medium/memory may also be used for storing data that is manipulated by the cellular baseband processor(s) 1724/application processor(s) 1706 when executing software. The cellular baseband processor(s) 1724/application processor(s) 1706 may be a component of the UE 350 and may include the memory 360 and/or at least one of the TX processor 368, the RX processor 356, and the controller/processor 359. In one configuration, the apparatus 1704 may be at least one processor chip (modem and/or application) and include just the cellular baseband processor(s) 1724 and/or the application processor(s) 1706, and in another configuration, the apparatus 1704 may be the entire UE (e.g., see 350 of FIG. 3) and include the additional modules of the apparatus 1704.

As discussed supra, the AGC transmission component 197 is configured to receive an allocation of resources for an uplink transmission or a sidelink transmission with a starting symbol after a first symbol in a slot; and transmit in a first symbol of the slot corresponding to the uplink transmission or the sidelink transmission, which may be referred to as a first uplink or sidelink symbol of the slot. The AGC transmission component 197 may be configured to receive, via at least one of RRC signaling, DCI, or MAC-CE, an indication to transmit the first symbol of each slot in which resources are allocated for the uplink transmission or the sidelink transmission beginning after the first symbol of the slot. The AGC transmission component 197 may be configured to receive a configuration indicating the set of the one or more resource elements for the AGC. The AGC transmission component 197 may be further configured to perform any of the aspects described in connection with the flowcharts in FIG. 12, 13, 15, or 16, and/or the aspects performed by the UEs in the communication flow diagrams in FIGS. 10 and/or 11. The AGC transmission component 197 may be within the cellular baseband processor(s) 1724, the application processor(s) 1706, or both the cellular baseband processor(s) 1724 and the application processor(s) 1706. The AGC transmission component 197 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the functions individually or in combination. As shown, the apparatus 1704 may include a variety of components configured for various functions. In one configuration, the apparatus 1704, and in particular the cellular baseband processor(s) 1724 and/or the application processor(s) 1706, includes means for receiving an allocation of resources for an uplink transmission or a sidelink transmission with a starting symbol after a first symbol in a slot. The apparatus includes means for transmitting in a first symbol of the slot corresponding to the uplink transmission or the sidelink transmission, which may be referred to as a first uplink or sidelink symbol of the slot. The apparatus further includes means for receiving, via at least one of RRC signaling, DCI, or MAC-CE, an indication to transmit the first symbol of each slot in which resources are allocated for the uplink transmission or the sidelink transmission beginning after the first symbol of the slot. The apparatus further includes means for receiving a configuration indicating the set of the one or more resource elements for the AGC. The apparatus may further include means for performing any of the aspects described in connection with the flowcharts in FIG. 12, 13, 15, or 16, and/or the aspects performed by the UEs in the communication flow diagrams in FIGS. 10 and/or 11. The means may be the AGC transmission component 197 of the apparatus 1704 configured to perform the functions recited by the means. As described supra, the apparatus 1704 may include the TX processor 368, the RX processor 356, and the controller/processor 359. As such, in one configuration, the means may be the TX processor 368, the RX processor 356, and/or the controller/processor 359 configured to perform the functions recited by the means.

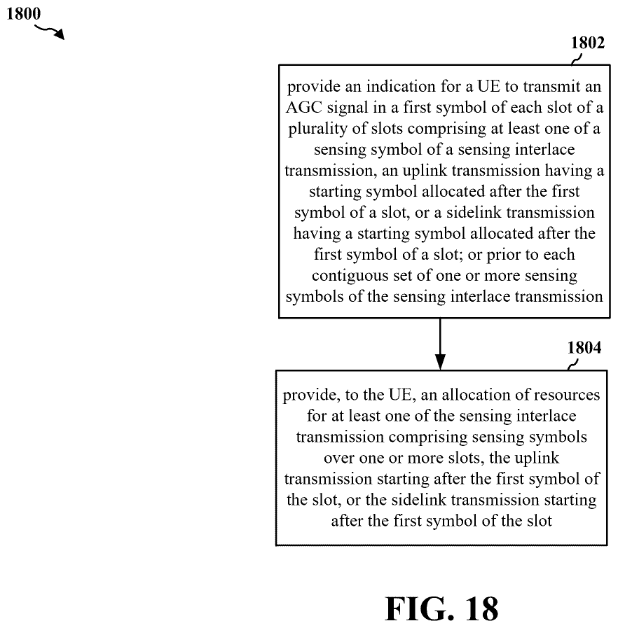

FIG. 18 is a flowchart 1800 of a method of wireless communication. The method may be performed by a network node or network entity such as a base station or one or more components of a base station (e.g., the base station 102, 310, 1004, 1104; the CU 110; the DU 130; the RU 140; the network entity 2002). The aspects may be performed by the network node in aggregation, such as by a base station in aggregated form, or by one or more components of a disaggregated base station. One or more of the illustrated operations may be omitted, transposed, or contemporaneous. The method may configure a UE to perform an enhanced sensing interlace transmission procedure.

At 1802, the network entity may provide an indication for a UE to transmit an AGC signal in a first symbol of each slot of a plurality of slots. For example, 1802 may be performed by the interlace transmission component 199 of network entity 2002. As an example, FIG. 10 and FIG. 11 illustrate examples of a base station 1104 transmitting an indication (e.g., 1008, 1010, 1106, and/or 1110) to a UE 1002 and 1102, respectively The network entity may provide the indication for the UE to transmit the AGC signal in the first symbol of each slot of the plurality of slots comprising at least one of an sensing symbol of a sensing interlace transmission, an uplink transmission having a starting symbol allocated after the first symbol of a slot. The use of the first symbol may include any of the aspects described in connection with FIGS. 6-9, for example. The network entity may provide the indication for the UE to transmit the AGC signal in the first symbol of each slot of the plurality of slots comprising a sidelink transmission having a starting symbol allocated after the first symbol of a slot. The network entity may provide the indication for the UE to transmit the AGC signal in the first symbol of each slot of the plurality of slots prior to each contiguous set of one or more sensing symbols of the sensing interlace transmission. In some aspects, to provide the indication for the UE may include providing the indication to transmit the AGC signal in the first symbol of each slot of the plurality of slots comprising at least one sensing symbol of the sensing interlace transmission, and the allocation of resources is for the sensing interlace transmission comprising the sensing symbols over the plurality of slots. In some aspects, the indication may be included in at least one of RRC signaling, DCI, or MAC-CE. In some aspects, to provide the indication for the UE may include providing the indication to transmit the AGC signal in the first symbol of the slot comprising the at least one sensing symbol of the uplink transmission having the starting symbol allocated after the first symbol of the slot, and the allocation of the resources is for the uplink transmission having the starting symbol allocated after the first symbol of the slot. In some aspects, to provide the indication for the UE may include providing the indication to transmit the AGC signal in the first symbol of the slot comprising the at least one sensing symbol of the sidelink transmission having the starting symbol allocated after the first symbol of the slot, and the allocation of the resources is for the sidelink transmission having the starting symbol allocated after the first symbol of the slot. In some aspects, to provide the indication for the UE may include providing the indication to transmit the AGC signal prior to each contiguous set of one or more sensing symbols of the sensing interlace transmission, and the allocation of resources is for the sensing interlace transmission comprising the sensing symbols over the one or more slots.

At 1804, the network entity may provide an allocation of resources. For example, 1804 may be performed by the interlace transmission component 199 of network entity 2002. FIG. 10 and FIG. 11 illustrate examples of a base station 1004 and 1104 transmitting a resource allocation to a UE 1002 and 1102 (e.g., at 1012 and 1108). The network entity may provide the allocation of resources for at least one of the sensing interlace transmission comprising sensing symbols over one or more slots, the uplink transmission starting after the first symbol of the slot, or the sidelink transmission starting after the first symbol of the slot. The network entity may provide the allocation of resources to the UE.

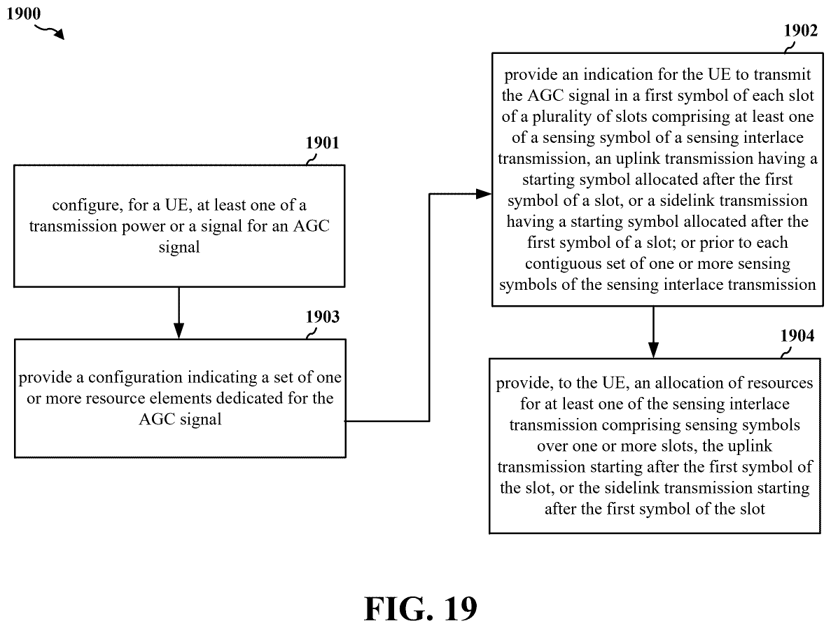

FIG. 19 is a flowchart 1900 of a method of wireless communication. The method may be performed by a network node or network entity such as a base station or one or more components of a base station (e.g., the base station 102, 310, 1004, 1104; the CU 110; the DU 130; the RU 140; the network entity 1902). The aspects may be performed by the network node in aggregation, such as by a base station in aggregated form, or by one or more components of a disaggregated base station. One or more of the illustrated operations may be omitted, transposed, or contemporaneous. The method may configure a UE to perform an enhanced sensing interlace transmission procedure.

At 1901, the network entity may configure at least one of a transmission power or a signal for an AGC signal. As an example, FIG. 10 and FIG. 11 illustrate examples of a base station 1104 transmitting a configuration (e.g., 1008 or 1106) to a UE 1002 and 1102, respectively. For example, 2002 may be performed by the interlace transmission component 199 of network entity 1902. The network entity may configure at least one of the transmission power or the signal for the AGC signal for a UE. The configuration of the transmission power or the signal for the AGC signal may be part of a sensing interlace transmission procedure for the UE.

As an example, at 1903, the network entity may provide a configuration indicating a set of one or more resource elements dedicated for the AGC signal. As an example, FIG. 10 and FIG. 11 illustrate examples of a base station 1104 transmitting a configuration (e.g., 1008 or 1106) to a UE 1002 and 1102, respectively. For example, 1904 may be performed by the interlace transmission component 199 of network entity 2002. The network entity may provide, to the UE, the configuration indicating the set of the one or more resource elements dedicated for the AGC signal.

At 1902, the network entity may provide an indication for a UE to transmit an AGC signal in a first symbol of each slot of a plurality of slots. As an example, FIG. 10 and FIG. 11 illustrate examples of a base station 1104 transmitting an indication (e.g., 1008, 1010, 1106, and/or 1110) to a UE 1002 and 1102, respectively. For example, 1906 may be performed by the interlace transmission component 199 of network entity 2002. The network entity may provide the indication for the UE to transmit the AGC signal in the first symbol of each slot of the plurality of slots comprising at least one of an sensing symbol of a sensing interlace transmission, an uplink transmission having a starting symbol allocated after the first symbol of a slot. The network entity may provide the indication for the UE to transmit the AGC signal in the first symbol of each slot of the plurality of slots comprising a sidelink transmission having a starting symbol allocated after the first symbol of a slot. The network entity may provide the indication for the UE to transmit the AGC signal in the first symbol of each slot of the plurality of slots prior to each contiguous set of one or more sensing symbols of the sensing interlace transmission. In some aspects, to provide the indication for the UE may include providing the indication to transmit the AGC signal in the first symbol of each slot of the plurality of slots comprising at least one sensing symbol of the sensing interlace transmission, and the allocation of resources is for the sensing interlace transmission comprising the sensing symbols over the plurality of slots. In some aspects, the indication may be included in at least one of RRC signaling, DCI, or MAC-CE. In some aspects, to provide the indication for the UE may include providing the indication to transmit the AGC signal in the first symbol of the slot comprising the at least one sensing symbol of the uplink transmission having the starting symbol allocated after the first symbol of the slot, and the allocation of the resources is for the uplink transmission having the starting symbol allocated after the first symbol of the slot. In some aspects, to provide the indication for the UE may include providing the indication to transmit the AGC signal in the first symbol of the slot comprising the at least one sensing symbol of the sidelink transmission having the starting symbol allocated after the first symbol of the slot, and the allocation of the resources is for the sidelink transmission having the starting symbol allocated after the first symbol of the slot. In some aspects, to provide the indication for the UE may include providing the indication to transmit the AGC signal prior to each contiguous set of one or more sensing symbols of the sensing interlace transmission, and the allocation of resources is for the sensing interlace transmission comprising the sensing symbols over the one or more slots.

At 1908, the network entity may provide an allocation of resources. For example, 1908 may be performed by the interlace transmission component 199 of network entity 2002. The network entity may provide the allocation of resources for at least one of the sensing interlace transmission comprising sensing symbols over one or more slots, the uplink transmission starting after the first symbol of the slot, or the sidelink transmission starting after the first symbol of the slot. The network entity may provide the allocation of resources to the UE.

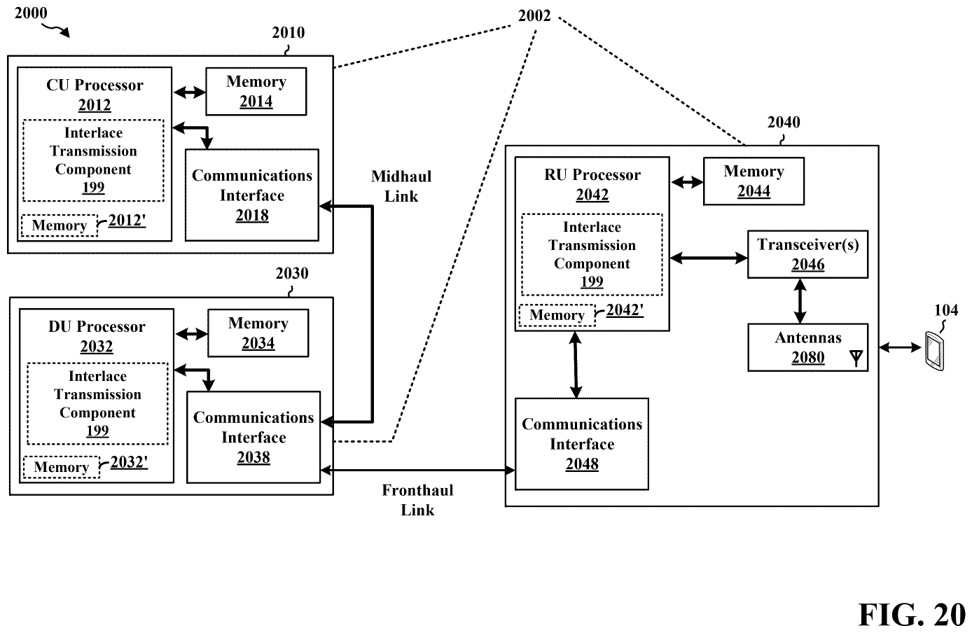

FIG. 20 is a diagram 2000 illustrating an example of a hardware implementation for a network entity 2002, which may also be referred to interchangeably as a network node. The network entity 2002 may be a base station, a component of a base station, or may implement base station functionality. In some aspects, the network entity 2002 may correspond to one or more components of the base station 102, 310, 1004, or 1104. The network entity 2002 may include at least one of a CU 2010, a DU 2030, or an RU 2040. For example, depending on the layer functionality handled by the interlace transmission component 199, the network entity 2002 may include the CU 2010; both the CU 2010 and the DU 2030; each of the CU 2010, the DU 2030, and the RU 2040; the DU 2030; both the DU 2030 and the RU 2040; or the RU 2040. The CU 2010 may include at least one CU processor 2012. The CU processor 2012 may include on-chip memory 2012′. In some aspects, the CU 2010 may further include additional memory modules 2014 and a communications interface 2018. The CU 2010 communicates with the DU 2030 through a midhaul link, such as an F1 interface. The DU 2030 may include at least one DU processor 2032. The DU processor 2032 may include on-chip memory 2032′. In some aspects, the DU 2030 may further include additional memory modules 2034 and a communications interface 2038. The DU 2030 communicates with the RU 2040 through a fronthaul link. The RU 2040 may include at least one RU processor 2042. The RU processor 2042 may include on-chip memory 2042′. In some aspects, the RU 2040 may further include additional memory modules 2044, one or more transceivers 2046, antennas 2080, and a communications interface 2048. The RU 2040 communicates with the UE 104. The on-chip memory 2012′, 2032′, 2042′ and the additional memory modules 2014, 2034, 2044 may each be considered a computer-readable medium/memory. Each computer-readable medium/memory may be non-transitory. Each of the processors 2012, 2032, 2042 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the interlace transmission component 199 is configured to provide an indication for a UE to transmit an AGC signal in a first symbol of each slot of a plurality of slots comprising at least one of an sensing symbol of a sensing interlace transmission, an uplink transmission having a starting symbol allocated after the first symbol of a slot, or a sidelink transmission having a starting symbol allocated after the first symbol of a slot; or prior to each contiguous set of one or more sensing symbols of the sensing interlace transmission; and provide, to the UE, an allocation of resources for at least one of the sensing interlace transmission comprising sensing symbols over one or more slots, the uplink transmission starting after the first symbol of the slot, or the sidelink transmission starting after the first symbol of the slot. The interlace transmission component 199 may be configured to configure, for the UE, at least one of a transmission power or a signal for the AGC signal. The interlace transmission component 199 may be configured to provide a configuration indicating a set of one or more resource elements dedicated for the AGC signal. The interlace transmission component 199 may be further configured to perform any of the aspects described in connection with the flowchart in FIG. 18 or 19, and/or any of the aspects performed by the base station in FIGS. 10 and/or 11. The interlace transmission component 199 may be within one or more processors of one or more of the CU 2010, DU 2030, and the RU 2040. The interlace transmission component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 2002 may include a variety of components configured for various functions. When multiple processors and implemented, the multiple processors may perform the functions individually or in combination. In one configuration, the network entity 2002 includes means for providing an indication for a UE to transmit an AGC signal in a first symbol of each slot of a plurality of slots comprising at least one of an active symbol of a sensing interlace transmission, an uplink transmission having a starting symbol allocated after the first symbol of a slot, or a sidelink transmission having a starting symbol allocated after the first symbol of a slot; or prior to each contiguous set of one or more sensing symbols of the sensing interlace transmission. The network entity includes means for providing, to the UE, an allocation of resources for at least one of the sensing interlace transmission comprising sensing symbols over one or more slots, the uplink transmission starting after the first symbol of the slot, or the sidelink transmission starting after the first symbol of the slot. The network entity further includes means for configuring, for the UE, at least one of a transmission power or a signal for the AGC signal. The network entity further includes means for providing a configuration indicating a set of one or more resource elements dedicated for the AGC signal. The network entity may further include means for performing any of the aspects described in connection with the flowchart in FIG. 18 or 19, and/or any of the aspects performed by the base station in FIGS. 10 and/or 11. The means may be the interlace transmission component 199 of the network entity 2002 configured to perform the functions recited by the means. As described supra, the network entity 2002 may include the TX processor 316, the RX processor 370, and the controller/processor 375. As such, in one configuration, the means may be the TX processor 316, the RX processor 370, and/or the controller/processor 375 configured to perform the functions recited by the means.

Aspects presented herein provide a configuration for AGC patterns for minimizing AGC issues in time-interlaced sensing transmissions. For example, the disclosure proposes an enhanced sensing AGC symbol format to accommodate instances where frequency domain multiplexed sensing transmissions are not aligned and/or are frequency domain multiplexing with transmissions (e.g., uplink or sidelink).

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE comprising transmitting a sensing interlace transmission comprising an interlace pattern of sensing symbols over a plurality of slots; and transmitting an AGC signal in a first symbol of each slot of the plurality of slots comprising at least one sensing symbol of the sensing interlace transmission or prior to each contiguous set of one or more sensing symbols of the sensing interlace transmission.

Aspect 2 is the method of aspect 1, further including transmitting the AGC signal in the first symbol of each slot of the plurality of slots comprising the at least one sensing symbol of the sensing interlace transmission.

Aspect 3 is the method of any of aspects 1 and 2, further including receiving, via at least one of RRC signaling, DCI, or MAC-CE, an indication to transmit the AGC signal in the first symbol of each slot of the plurality of slots comprising the at least one sensing symbol or prior to each contiguous set of one or more sensing symbols of the sensing interlace transmission.

Aspect 4 is the method of any of aspects 1-3, further including transmitting the AGC signal at a transmission power that is common to the sensing interlace transmission in other symbols within a same slot as the AGC signal.

Aspect 5 is the method of any of aspects 1-4, further includes that the AGC signal comprises at least one of a configured signal, a defined signal, a repetition of a first sensing transmission symbol of the sensing interlace transmission, a signal based on rate matching of data over an extended number transmit resources, or a UE selected signal.

Aspect 6 is the method of any of aspects 1-5, further including transmitting the AGC signal prior to each contiguous set of one or more sensing symbols of the sensing interlace transmission.

Aspect 7 is the method of any of aspects 1-6, further includes that an AGC symbol is included with each of the at least one sensing symbol, wherein the AGC symbol uses a same frequency pattern as each of the at least one sensing symbol within a same slot.

Aspect 8 is the method of any of aspects 1-7, further including transmitting the AGC signal in a set of one or more resource elements dedicated for the AGC signal.

Aspect 9 is the method of any of aspects 1-8, further including receiving a configuration indicating the set of one or more resource elements for the AGC signal.

Aspect 10 is the method of any of aspects 1-9, further including transmitting the AGC signal in resource elements spanning a frequency range of the sensing interlace transmission.

Aspect 11 is an apparatus for wireless communication at a UE including at least one processor coupled to a memory and at least one transceiver, the at least one processor configured to cause the UE to implement any of Aspects 1-10.

Aspect 12 is an apparatus for wireless communication at a UE including means for implementing any of Aspects 1-10.

Aspect 13 is a computer-readable medium storing computer executable code, where the code when executed by a processor causes the processor to implement any of Aspects 1-10.

Aspect 14 is a method of wireless communication at a UE comprising receiving an allocation of resources for an uplink transmission or a sidelink transmission with a starting symbol after a first symbol in a slot; and transmitting in the first symbol of the slot corresponding to the uplink transmission or the sidelink transmission.

Aspect 15 is the method of aspect 14, further including transmitting at least one of an AGC signal or a portion of communication for the uplink transmission or the sidelink transmission in the first symbol of the slot.

Aspect 16 is the method of any of aspects 14 and 15, further including transmit the AGC signal in the first symbol of the slot, the AGC signal comprising at least one of a configured signal, a defined signal, a repetition of a first uplink or sidelink symbol of the uplink transmission or the sidelink transmission, a signal based on rate matching of data over an extended number transmit resources, or a UE selected signal.

Aspect 17 is the method of any of aspects 14-16, further including receiving, via at least one of RRC signaling, DCI, or MAC-CE, an indication to transmit the first symbol of each slot in which resources are allocated for the uplink transmission or the sidelink transmission beginning after the first symbol of the slot.

Aspect 18 is the method of any of aspects 14-17, further including transmitting in a set of one or more resource elements dedicated for AGC.

Aspect 19 is the method of any of aspects 14-18, further including receiving a configuration indicating the set of one or more resource elements for the AGC.

Aspect 20 is the method of any of aspects 14-19, further including transmitting in resource elements spanning a frequency range of the uplink transmission or the sidelink transmission.

Aspect 21 is an apparatus for wireless communication at a UE including at least one processor coupled to a memory and at least one transceiver, the at least one processor configured to cause the UE to implement any of Aspects 14-20.

Aspect 22 is an apparatus for wireless communication at a UE including means for implementing any of Aspects 14-20.

Aspect 23 is a computer-readable medium storing computer executable code, where the code when executed by a processor causes the processor to implement any of Aspects 14-20.

Aspect 24 is a method of wireless communication at a network entity, comprising providing an indication for a UE to transmit an AGC signal in a first symbol of each slot of a plurality of slots comprising at least one of an sensing symbol of a sensing interlace transmission, an uplink transmission having an uplink starting symbol allocated after the first symbol of a slot, or a sidelink transmission having a sidelink starting symbol allocated after the first symbol of the slot; or prior to each contiguous set of one or more sensing symbols of the sensing interlace transmission; and providing, to the UE, an allocation of resources for at least one of the sensing interlace transmission comprising sensing symbols over one or more slots, the uplink transmission starting after the first symbol of the slot, or the sidelink transmission starting after the first symbol of the slot.

Aspect 25 is the method of aspect 24, further including providing the indication to transmit the AGC signal in the first symbol of each slot of the plurality of slots comprising at least one sensing symbol of the sensing interlace transmission, and the allocation of resources is for the sensing interlace transmission comprising the sensing symbols over the plurality of slots.

Aspect 26 is the method of any of aspects 24 and 25, further includes that the indication is included in at least one of RRC signaling, DCI, or MAC-CE.

Aspect 27 is the method of any of aspects 24-26, further including providing the indication to transmit the AGC signal in the first symbol of the slot comprising at least one sensing symbol of the uplink transmission having the uplink starting symbol allocated after the first symbol of the slot, and the allocation of the resources is for the uplink transmission having the uplink starting symbol allocated after the first symbol of the slot.

Aspect 28 is the method of any of aspects 24-27, further including providing the indication to transmit the AGC signal in the first symbol of the slot comprising at least one sensing symbol of the sidelink transmission having the sidelink starting symbol allocated after the first symbol of the slot, and the allocation of the resources is for the sidelink transmission having the sidelink starting symbol allocated after the first symbol of the slot.

Aspect 29 is the method of any of aspects 24-28, further including configure, for the UE, at least one of a transmission power or a signal for the AGC signal.

Aspect 30 is the method of any of aspects 24-29, further including providing the indication to transmit the AGC signal prior to each contiguous set of one or more sensing symbols of the sensing interlace transmission, and the allocation of resources is for the sensing interlace transmission comprising the sensing symbols over the one or more slots.

Aspect 31 is the method of any of aspects 24-30, further including providing a configuration indicating a set of one or more resource elements dedicated for the AGC signal.

Aspect 32 is an apparatus for wireless communication at a network entity including at least one processor coupled to a memory and at least one transceiver, the at least one processor configured to cause the network entity to implement any of Aspects 24-31.

Aspect 33 is an apparatus for wireless communication at a network entity including means for implementing any of Aspects 24-31.

Aspect 34 is a computer-readable medium storing computer executable code, where the code when executed by a processor causes the processor to implement any of Aspects 24-31.

1. An apparatus for wireless communication at a user equipment (UE), comprising: at least one memory; and
at least one processor coupled to the at least one memory and, based at least in part on information stored in the at least one memory, the at least one processor is configured to:
transmit a sensing interlace transmission comprising an interlace pattern of sensing symbols over a plurality of slots; and
transmit an automatic gain control (AGC) signal in a first symbol of each slot of the plurality of slots comprising at least one sensing symbol of the sensing interlace transmission or prior to each contiguous set of one or more sensing symbols of the sensing interlace transmission.

2. The apparatus of claim 1, further comprising a transceiver coupled to the at least one processor, wherein the at least one processor is configured to transmit the sensing interlace transmission and the AGC signal via the transceiver.

3. The apparatus of claim 1, wherein to transmit the AGC signal, the at least one processor is configured to transmit the AGC signal in the first symbol of each slot of the plurality of slots comprising the at least one sensing symbol of the sensing interlace transmission.

4. The apparatus of claim 1, wherein the at least one processor is configured to:
receive, via at least one of radio resource control (RRC) signaling, downlink control information (DCI), or medium access control (MAC) control element (CE) (MAC-CE), an indication to transmit the AGC signal in the first symbol of each slot of the plurality of slots comprising the at least one sensing symbol or prior to each contiguous set of one or more sensing symbols of the sensing interlace transmission.

5. The apparatus of claim 1, wherein to transmit the AGC signal in the first symbol, the at least one processor is configured to transmit the AGC signal at a transmission power that is common to the sensing interlace transmission in other symbols within a same slot as the AGC signal.

6. The apparatus of claim 5, wherein the AGC signal comprises at least one of:
a configured signal,
a defined signal,
a repetition of a first sensing transmission symbol of the sensing interlace transmission,
a signal based on rate matching of data over an extended number transmit resources, or
a UE selected signal.

7. The apparatus of claim 1, wherein to transmit the AGC signal, the at least one processor is configured to transmit the AGC signal prior to each contiguous set of one or more sensing symbols of the sensing interlace transmission.

8. The apparatus of claim 1, wherein an AGC symbol is included with each of the at least one sensing symbol, wherein the AGC symbol uses a same frequency pattern as each of the at least one sensing symbol within a same slot.

9. The apparatus of claim 1, wherein to transmit the AGC signal, the at least one processor is configured to transmit the AGC signal in a set of one or more resource elements dedicated for the AGC signal.

10. The apparatus of claim 9, wherein the at least one processor is configured to:
receive a configuration indicating the set of one or more resource elements for the AGC signal.

11. The apparatus of claim 1, wherein to transmit the AGC signal, the at least one processor is configured to transmit the AGC signal in resource elements spanning a frequency range of the sensing interlace transmission.

12. (canceled)

13. An apparatus for wireless communication at a user equipment (UE) comprising: at least one memory; and
at least one processor coupled to the at least one memory and, based at least in part on information stored in the at least one memory, the at least one processor is configured to:
receive an allocation of resources for an uplink transmission or a sidelink transmission with a starting symbol after a first symbol in a slot; and
transmit in the first symbol of the slot corresponding to the uplink transmission or the sidelink transmission.

14. The apparatus of claim 13, further comprising a transceiver coupled to the at least one processor, wherein the at least one processor is configured to receive the allocation of resources and transmit in the first symbol of the slot via the transceiver.

15. The apparatus of claim 13, wherein to transmit in the first symbol of the slot,
the at least one processor is configured to transmit at least one of an automatic gain control (AGC) signal or a portion of communication for the uplink transmission or the sidelink transmission in the first symbol of the slot.

16. The apparatus of claim 15, wherein the at least one processor is configured to transmit the AGC signal in the first symbol of the slot, the AGC signal comprising at least one of:
a configured signal,
a defined signal,
a repetition of a first uplink or sidelink symbol of the uplink transmission or the sidelink transmission,
a signal based on rate matching of data over an extended number transmit resources, or
a UE selected signal.

17. The apparatus of claim 13, wherein the at least one processor is configured to:
receive, via at least one of radio resource control (RRC) signaling, downlink control information (DCI), or medium access control (MAC) control element (CE) (MAC-CE), an indication to transmit the first symbol of each slot in which resources are allocated for the uplink transmission or the sidelink transmission beginning after the first symbol of the slot.

18. The apparatus of claim 13, wherein to transmit in the first symbol of the slot, the at least one processor is configured to transmit in a set of one or more resource elements dedicated for automatic gain control (AGC).

19. The apparatus of claim 18, wherein the at least one processor is configured to:
receive a configuration indicating the set of one or more resource elements for the AGC.

20. The apparatus of claim 13, wherein to transmit in the first symbol of the slot, the at least one processor is configured to transmit in resource elements spanning a frequency range of the uplink transmission or the sidelink transmission.

21. (canceled)

22. An apparatus for wireless communication at a network node, comprising:
at least one memory; and
at least one processor coupled to the at least one memory and, based at least in part on information stored in the at least one memory, the at least one processor is configured to:
provide an indication for a user equipment (UE) to transmit an automatic gain control (AGC) signal in a first symbol of each slot of a plurality of slots
comprising at least one of an sensing symbol of a sensing interlace transmission, an uplink transmission having an uplink starting symbol allocated after the first symbol of a slot, or a sidelink transmission having a sidelink starting symbol allocated after the first symbol of the slot, or prior to each contiguous set of one or more sensing symbols of the sensing interlace transmission; and
provide, to the UE, an allocation of resources for at least one of the sensing interlace transmission comprising sensing symbols over one or more slots, the uplink transmission starting after the first symbol of the slot, or the sidelink transmission starting after the first symbol of the slot.

23-30. (canceled)
